(19) United States
(12) Patent Application Publication
(10) Pub. No.: US 2017/0280189 A1
(43) Pub. Date: Sep. 28, 2017

(54) Method For Acquiring Interactive Information, Terminal, Server And System

(71) Applicant: Tencent Technology (Shenzhen) Company Limited, Shenzhen (CN)

(72) Inventors: Wa YE, Shenzhen (CN); Jing ZANG, Shenzhen (CN); Zhenyu XU, Shenzhen (CN); Keren LI, Shenzhen (CN); Hongyang WANG, Shenzhen (CN); Xucheng TANG, Shenzhen (CN); Yongjie LI, Shenzhen (CN); Zhuo TANG, Shenzhen (CN); Rui WANG, Shenzhen (CN)

(73) Assignee: Tencent Technology (Shenzhen) Company Limited, Shenzhen (CN)

(21) Appl. No.: 15/359,791

(22) Filed: Nov. 23, 2016

Related U.S. Application Data
(63) Continuation of application No. PCT/CN2015/079961, filed on May 27, 2015.

(30) Foreign Application Priority Data
May 29, 2014 (CN) 201410235379.4

(51) Int. Cl. H04N 21/439; H04N 21/845; H04N 21/435; H04N 21/472; H04N 21/8545; H04N 21/44

(52) U.S. Cl. CPC H04N 21/439; H04N 21/8545; H04N 21/44; H04N 21/435; H04N 21/47217; H04N 21/845; G06F 17/30044

(57) ABSTRACT

A method for acquiring interactive information is provided, including: acquiring an interactive instruction; determining time information of the interactive instruction; acquiring multimedia data related to the time information; sending an interactive information acquisition request at least including the multimedia data and the time information; and receiving interactive information matching the multimedia data and the time information in the interactive information acquisition request. The terminal determines time information; acquires multimedia data related to the time information; sends an interactive information acquisition request at least including the multimedia data and the time information; and receives interactive information matching the multimedia data and the time information in the interactive information acquisition request.

### CROSS REFERENCE TO RELATED APPLICATION

This application is a continuation application of International Application No. PCT/CN2015/079961, titled “METHOD FOR ACQUIRING INTERACTIVE INFORMATION, TERMINAL, SERVER AND SYSTEM”, filed on May 27, 2015, which claims priority to Chinese Patent Application No. 201410235379.4, filed on May 29, 2014, both of which are incorporated herein by reference in their entireties.

### TECHNICAL FIELD

The present disclosure relates to the field of information processing technologies, and in particular, to a method for acquiring interactive information, a terminal, a server and a system.

### BACKGROUND

TV media often increase interactive sessions during program broadcasting with the purpose of improving program audience rating or improving program quality or the like. For example, description information for describing interactive content, interactive information acquisition manners and other content is broadcast while a program is broadcast; and after the description information is acquired, corresponding interactive information can be acquired according to the description information, thereby participating in interaction. Therefore, how to simply and rapidly acquire interactive information becomes an urgent issue.

At present, there are three methods for acquiring interactive information:

The first method for acquiring interactive information includes: acquiring a two-dimensional code, sending the two-dimensional code, and then receiving interactive information published by a public number corresponding to the two-dimensional code.

The second method for acquiring interactive information includes: acquiring an interactive information acquisition instruction input by a user through an input device, sending the interactive information acquisition instruction, and then receiving interactive information matching the interactive information acquisition instruction.

The third method for acquiring interactive information includes: acquiring an interactive information acquisition signal sent by a user by operating a remote control, sending the interactive information acquisition signal, and then receiving interactive information matching the interactive information acquisition signal.

During implementation of the present disclosure, the inventor finds that the methods at least have the following disadvantages:

For the first method for acquiring interactive information, it is necessary to acquire a two-dimensional code, it is difficult to unify resolution of devices displaying the two-dimensional code, and thus a situation where lower resolution of a device displaying the two-dimensional code causes failure of acquisition of the two-dimensional code may occur, thereby leading to failure of acquisition of interactive information, which limits implementation scenarios of the method. For the second method for acquiring interactive information, as an interactive information acquisition instruction is input by a user through an input device, the probability of an incorrect interactive information acquisition instruction caused by an input error is increased, thereby increasing the probability of incorrect acquisition of interactive information. For the third method for acquiring interactive information, as an interactive information acquisition signal is sent by a user by operating a remote control, the probability of an incorrect interactive information acquisition signal caused by an incorrect operation on the remote control is increased, thereby increasing the probability of incorrect acquisition of interactive information.

### SUMMARY

In a first aspect, a method for acquiring interactive information is provided, the method including:
acquiring an interactive instruction;
determining time information of the interactive instruction;
acquiring multimedia data related to the time information; sending an interactive information acquisition request at least including the multimedia data and the time information; and receiving interactive information matching the multimedia data and the time information in the interactive information acquisition request.

In a second aspect, a terminal is provided, the terminal including:
a first acquisition module, configured to acquire an interactive instruction;
a determination module, configured to determine time information of the interactive instruction acquired by the first acquisition module;
a second acquisition module, configured to acquire multimedia data related to the time information determined by the determination module;
a sending module, configured to send an interactive information acquisition request at least including the multimedia data acquired by the second acquisition module and the time information determined by the determination module; and
a receiving module, configured to receive interactive information matching the multimedia data and the time information in the interactive information acquisition request sent by the sending module.

In a third aspect, a server is provided, the server including:
a first acquisition module, configured to acquire an interactive information acquisition request;
a second acquisition module, configured to acquire time information related to the interactive information acquisition request acquired by the first acquisition module, the interactive information acquisition request at least including multimedia data;
a third acquisition module, configured to acquire program information matching the multimedia data;
a fourth acquisition module, configured to acquire interactive information matching the program information acquired by the third acquisition module and the time information acquired by the second acquisition module; and
a sending module, configured to send the interactive information acquired by the fourth acquisition module.

### BRIEF DESCRIPTION OF THE DRAWINGS

To describe the technical solutions of the embodiments of the present invention more clearly, the following briefly introduces the accompanying drawings required for describing the embodiments. Apparently, the accompanying drawings in the following description show only some embodiments of the present invention, and a person of ordinary skill in the art may still derive other drawings from these accompanying drawings without creative efforts.

FIG. 1 is a schematic structural diagram of an implementation environment of a method for acquiring interactive information illustrated according to one exemplary embodiment;

FIG. 2 is a flowchart of a method for acquiring interactive information illustrated according to one exemplary embodiment;

FIG. 3 is a flowchart of a method for acquiring interactive information illustrated according to one exemplary embodiment;

FIG. 4 is a flowchart of a method for acquiring interactive information illustrated according to one exemplary embodiment;

FIG. 5 is a schematic diagram of an operation interface of a mobile phone A illustrated according to one exemplary embodiment;

FIG. 6 is a schematic diagram of an implementation process of a method for acquiring interactive information illustrated according to one exemplary embodiment;

FIG. 7 is a flowchart of a method for acquiring interactive information illustrated according to one exemplary embodiment;

FIG. 8 is a schematic diagram of an implementation process of a method for acquiring interactive information illustrated according to one exemplary embodiment;

FIG. 9 is a flowchart of a method for acquiring interactive information illustrated according to one exemplary embodiment;

FIG. 10 is a flowchart of a method for acquiring interactive information illustrated according to one exemplary embodiment;

FIG. 11 is a schematic structural diagram of a terminal illustrated according to one exemplary embodiment;

FIG. 12 is a schematic structural diagram of a terminal illustrated according to one exemplary embodiment;

FIG. 13 is a schematic structural diagram of a terminal illustrated according to one exemplary embodiment;

FIG. 14 is a schematic structural diagram of a server illustrated according to one exemplary embodiment;

FIG. 15 is a first schematic structural diagram of a third acquisition module illustrated according to one exemplary embodiment;

FIG. 16 is a second schematic structural diagram of a third acquisition module illustrated according to one exemplary embodiment;

FIG. 17 is a third schematic structural diagram of a third acquisition module illustrated according to one exemplary embodiment; and

FIG. 18 is a schematic structural diagram of a server illustrated according to one exemplary embodiment.

### DETAILED DESCRIPTION OF THE EMBODIMENTS

In order to make the objectives, technical solutions and advantages of the present disclosure clearer, implementations of the present disclosure are further described below in detail with reference to the accompanying drawings.

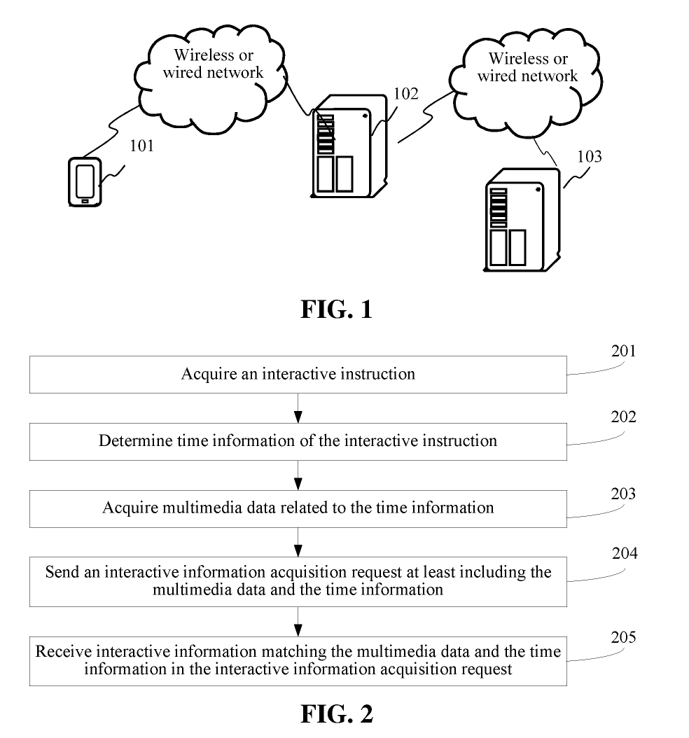

An embodiment of the present invention provides a method for acquiring interactive information; referring to FIG. 1, FIG. 1 is a schematic structural diagram of an implementation environment in which the method for acquiring interactive information provided in the embodiment of the present invention is involved. The implementation environment includes a terminal 101, a server 102 and a signal providing device 103.

The terminal 101 is a terminal in the following embodiment. The terminal 101 is configured to, after acquiring multimedia data according to an interactive instruction, send to the server 102 an interactive information acquisition request at least including the multimedia data, and receive interactive information matching the multimedia data and time information in the interactive information acquisition request returned by the server 102. The time information may be time information of the interactive instruction determined by the terminal, or time information of the interactive information acquisition request received by the server. The terminal 101 may be a smart phone, a remote control or a set-top box, or may be other forms of devices interacting with TVs. In addition, the devices may be devices independent of the TVs or devices integrated to the TVs, which are not limited herein in the embodiment of the present invention.

The server 102 is a server providing interactive information for the terminal 101, which is a server described in the following embodiment. After receiving the interactive information acquisition request at least including the multimedia data sent by the terminal 101, the server 102 is combined with the signal providing device 103 to acquire interactive information matching the multimedia data in the interactive information acquisition request.

The signal providing device 103 may be a server, and the signal providing device 103 is configured to be combined with the server 102 to acquire interactive information matching the multimedia data in the interactive information acquisition request.

The terminal 101, the server 102 and the signal providing device 103 may conduct communication therebetween through a wireless network or a wired network.

FIG. 2 is a flowchart of a method for acquiring interactive information illustrated according to one exemplary embodiment; as shown in FIG. 2, the method for acquiring interactive information is applied to a terminal, including the following steps.

201: Acquire an interactive instruction.

202: Determine time information of the interactive instruction.

203: Acquire multimedia data related to the time information.

Optionally, the acquiring multimedia data related to the time information includes:
acquiring an audio signal related to the time information, generating an audio fingerprint corresponding to the audio signal, and using the audio fingerprint as the acquired multimedia data.

Optionally, the acquiring multimedia data related to the time information includes:
acquiring an audio signal related to the time information, and using the audio signal as the acquired multimedia data.

Optionally, the acquiring multimedia data related to the time information includes:
acquiring image data related to the time information, and using the image data as the acquired multimedia data.

204: Send an interactive information acquisition request at least including the multimedia data and the time information.

205: Receive interactive information matching the multimedia data and the time information in the interactive information acquisition request.

Optionally, the method further includes: acquiring user information;
the sending an interactive information acquisition request at least including the multimedia data and the time information including: sending an interactive information acquisition request at least including the multimedia data, the user information and the time information; and
the receiving interactive information matching the multimedia data and the time information in the interactive information acquisition request including: receiving interactive information matching the multimedia data, the user information and the time information in the interactive information acquisition request.

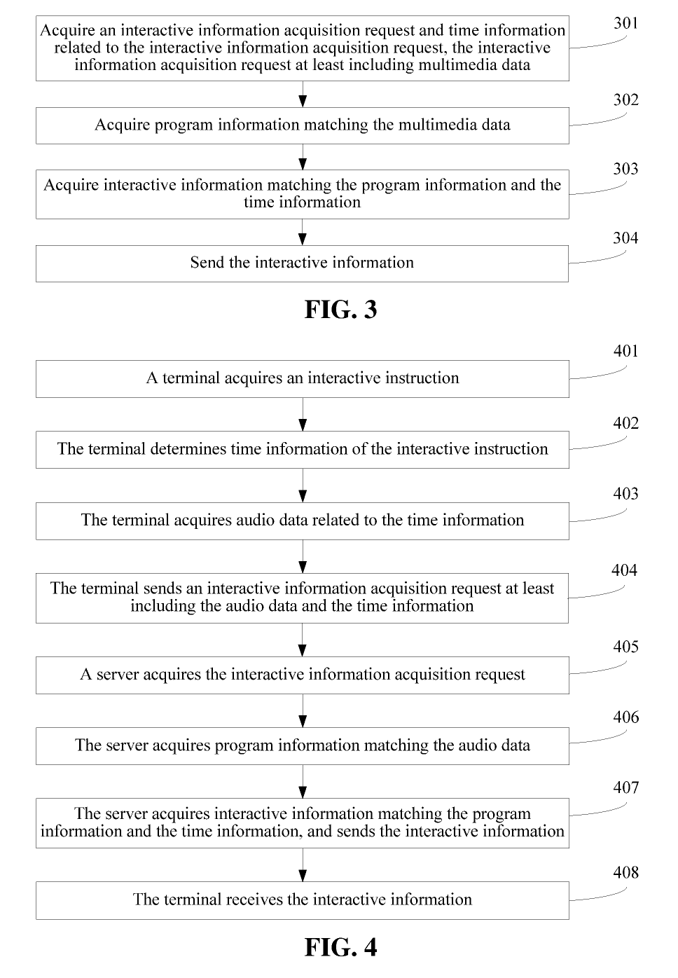

FIG. 3 is a flowchart of a method for acquiring interactive information illustrated according to one exemplary embodiment; as shown in FIG. 3, the method for acquiring interactive information is applied to a server, including the following steps.

301: Acquire an interactive information acquisition request and time information related to the interactive information acquisition request, the interactive information acquisition request at least including multimedia data.

302: Acquire program information matching the multimedia data.

Optionally, the multimedia data is an audio fingerprint; and
the acquiring program information matching the multimedia data includes:
sending the audio fingerprint; and
receiving program information matching the audio fingerprint, the program information at least including an audio signal, name and playback time information of a program matching the audio fingerprint.

Optionally, the multimedia data is an audio signal; and
the acquiring program information matching the multimedia data includes:
generating an audio fingerprint corresponding to the audio signal;
sending the audio fingerprint; and
receiving program information matching the audio fingerprint, the program information at least including an audio signal, name and playback time information of a program matching the audio fingerprint.

Optionally, the multimedia data is image data; and
the acquiring program information matching the multimedia data includes:
sending the image data; and
receiving program information matching the image data, the program information at least including an audio signal, name and playback time information of a program matching the image data.

303: Acquire interactive information matching the program information and the time information.

304: Send the interactive information.

Optionally, the interactive information acquisition request further includes user information; and
the acquiring interactive information matching the program information and the time information includes: acquiring interactive information matching the program information, the user information and the time information.

The method provided in this embodiment, by determining time information of an interactive instruction, acquiring multimedia data related to the time information, sending an interactive information acquisition request at least including the multimedia data and the time information, and receiving interactive information matching the multimedia data and the time information in the interactive information acquisition request, avoids the situation where lower resolution of a device displaying the two-dimensional code causes failure of acquisition of the interactive information and also avoids the situation where incorrect input of the interactive information acquisition instruction or an incorrect operation on the remote control causes failure of acquisition of the interactive information, thereby improving efficiency and accuracy of acquisition of the interactive information.

In order to expound the method for acquiring interactive information provided in the embodiment more clearly, the method for acquiring interactive information is described in detail in combination with the content and the implementation environment of the embodiment by taking the following embodiment as an example; please refer to the following embodiment for details:

FIG. 4 is a flowchart of a method for acquiring interactive information illustrated according to one exemplary embodiment; for ease of description, in this embodiment, the method provided in this embodiment is illustrated in detail by taking that the terminal is a mobile phone A, the server is a server A, the signal providing device is a server B, the multimedia data is audio data, and the mobile phone A acquires time information of an interactive instruction as an example. Referring to FIG. 4, the flow of the method provided in this embodiment is specifically as follows:

401: A terminal acquires an interactive instruction.

This embodiment does not limit the specific method for acquiring the interactive instruction by the terminal, which includes, but is not limited to, considering that the interactive instruction is acquired if the terminal detects a shaking action.

This embodiment does not limit the specific judgment condition of whether the terminal detects the shaking action, which includes, but is not limited to, if the terminal includes a position sensor, detecting whether the centre-of-gravity position of the terminal changes through the position sensor, and if it is detected through the position sensor that the centre-of-gravity position of the terminal changes, determining that the terminal detects the shaking action.

In addition to the method for acquiring an interactive instruction, a specific method for acquiring an interactive instruction may also be: considering that the interactive instruction is acquired if the terminal detects a preset fingerprint, or considering that the interactive instruction is acquired if the terminal detects a preset audio signal, or considering that the interactive instruction is acquired if the terminal detects a preset password.

In addition, in order to prevent mistakenly thinking other functional instructions as the interactive instruction in the method provided in this embodiment when the interactive instruction in the method provided in this embodiment is the same as the other functional instructions of the terminal, optionally, the terminal acquires the interactive instruction after an interactive instruction trigger condition is triggered. This embodiment does not limit the specific method through which the interactive instruction trigger condition is triggered. For example, if an interactive function is opened, it is considered that the interactive instruction trigger condition is triggered.

This embodiment does not limit the specific method for opening an interactive function either. For example, if the terminal provides multiple function options, wherein one function option is an interactive function option, it is considered that the interactive function is opened when the terminal acquires that the interactive function option is selected.

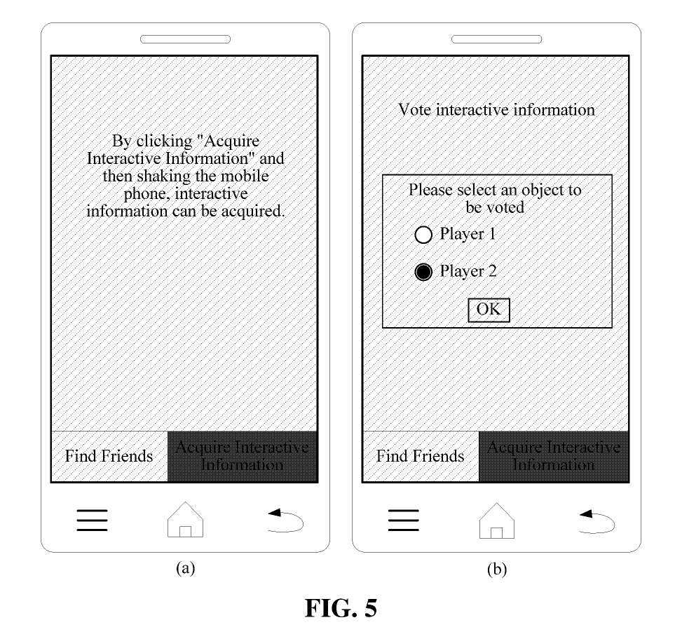

By taking an operation interface of a mobile phone A shown in FIG. 5(a) as an example, the mobile phone A provides two function options, that is, a friend-making function option “Find Friends” and an interactive function option “Acquire Interactive Information”. If the mobile phone A acquires that “Acquire Interactive Information” is selected, it is considered that the interactive function is opened. After the interactive function is opened, if the mobile phone A detects that the centre-of-gravity position of the mobile phone A changes through the position sensor included in the mobile phone A, it is determined that the mobile phone A detects a shaking action, and it is considered that the interactive instruction is acquired.

402: The terminal determines time information of the interactive instruction.

As the acquired interactive instruction may be an interactive instruction lasting for some time, for example, the acquired interactive instruction is a shaking action, the shaking action may continue to shake for some time, and thus the terminal may determine start time when the interactive instruction is acquired as time information of the interactive instruction. The terminal may also determine end time when the interactive instruction is acquired as time information of the interactive instruction. This embodiment does not limit the specific method for determining time information of the interactive instruction.

By taking that the mobile phone A starts to shake from 10:30:30 to 10:30:32 as an example, the mobile phone A acquires that start time of the shaking action is 10:30:30, and it is determined that time information of the interactive instruction is 10:30:30. Alternatively, the mobile phone A acquires that end time of the shaking action is 10:30:32, and it is determined that time information of the interactive instruction is 10:30:32.

Certainly, the start time of the shaking action may also be other time, and this embodiment does not limit the specific start time of the shaking action. The end time of the shaking action may also be other time, and this embodiment does not limit the specific end time of the shaking action.

403: The terminal acquires audio data related to the time information.

The audio data is an audio signal or an audio fingerprint. This embodiment does not limit the specific content representing the audio data.

For the situation where the audio data is an audio signal, during specific implementation of the step, it is feasible that the terminal collects an audio signal played by an audio playback device according to the time information while the audio playback device plays audio, so as to achieve interaction through the audio signal played by the audio playback device. In addition, the audio signal related to the time information may also be acquired through another method, and this embodiment does not limit the specific method for acquiring an audio signal related to the time information.

This embodiment does not limit the specific method for collecting an audio signal by the terminal according to time information. For example, the terminal collects an audio signal once every first preset time period according to time information, until the total time length of collection of the audio signal reaches a preset length. Alternatively, the terminal collects an audio signal with a preset duration according to time information. In addition, this embodiment does not limit the audio playback device, which includes, but is not limited to, TV sets, radios and other audio playback devices.

### Example 1

by taking that the time information is 10:30:30 and the audio playback device is a TV set as an example, if the first preset time period is 3 s, the preset time length is 15 s, and the duration of every audio signal collection is 3 s, the mobile phone A, from 10:30:30 to 10:30:33, collects a TV audio signal 1 played from 10:30:30 to 10:30:33 by the TV set, and the TV audio signal 1 is used as an audio signal 1 collected for the first time; at this time, the total duration during which the audio signal is collected is 3 s.

From 10:30:33 to 10:30:36, a TV audio signal 2 played from 10:30:33 to 10:30:36 by the TV set is collected, the TV audio signal 2 is used as an audio signal 2 collected for the second time, and at this time, the total duration during which the audio signal is collected is 6 s.

From 10:30:36 to 10:30:39, a TV audio signal 3 played from 10:30:36 to 10:30:39 by the TV set is collected, the TV audio signal 3 is used as an audio signal 3 collected for the third time, and at this time, the total duration during which the audio signal is collected is 9 s.

From 10:30:39 to 10:30:42, a TV audio signal 4 played from 10:30:39 to 10:30:42 by the TV set is collected, the TV audio signal 4 is used as an audio signal 4 collected for the fourth time, and at this time, the total duration during which the audio signal is collected is 12 s.

From 10:30:42 to 10:30:45, a TV audio signal 5 played from 10:30:42 to 10:30:45 by the TV set is collected, the TV audio signal 5 is used as an audio signal 5 collected for the fifth time, at this time, the total duration during which the audio signal is collected is 15 s, which reaches the preset time length of 15 s, and audio signal collection is stopped.

The TV audio signals are carriers of frequency and amplitude variation information of regular sound waves of TV programs with voice, music and sound effects.

Certainly, the audio playback device may also be another device, the first preset time period may also be another time length, the preset time length may also be another time length, the duration of every audio signal collection may also be another time length, the name of the collected audio signal may also be another name, and this embodiment does not limit the specific audio playback device, the specific value of the first preset time period, the specific value of the preset time length, the specific duration of every audio signal collection and the specific name of the collected audio signal.

In addition to the specific method for collecting an audio signal by the terminal according to time information, it may also be that the terminal only collects an audio signal once according to time information.

### Example 2

by taking that the time information is 10:30:30 and the audio playback device is a TV set as an example, if the duration of the audio signal collection is 3 s, the mobile phone A, from 10:30:30 to 10:30:33, collects a TV audio signal 6 played from 10:30:30 to 10:30:33 by the TV set, and the TV audio signal 6 is used as the collected audio signal 6.

For the situation where the audio data is an audio fingerprint, during specific implementation of the step, it is feasible to first acquire an audio signal related to the time information and then generate an audio fingerprint corresponding to the audio signal, so as to achieve interaction through the audio fingerprint corresponding to the audio signal.

This embodiment does not limit the specific method for generating an audio fingerprint corresponding to the audio signal, which includes, but is not limited to, if a corresponding relationship between preset audio signals and corresponding IDs is pre-stored, determining an ID corresponding to the acquired audio signal related to the time information according to a relationship between the preset audio signals and the acquired audio signal related to the time information and the pre-stored corresponding relationship between preset audio signals and corresponding IDs, and using the ID corresponding to the acquired audio signal related to the time information as an audio fingerprint.

Specifically, a relationship between any preset audio signal and the acquired audio signal related to the time information may be one of the following four relationships:
the first relationship: any preset audio signal is irrelevant to the acquired audio signal related to the time information;
the second relationship: any preset audio signal completely includes the acquired audio signal related to the time information;
the third relationship: any preset audio signal partially includes the acquired audio signal related to the time information; and
the fourth relationship: any preset audio signal is completely included in the acquired audio signal related to the time information.

That the preset audio signals are three preset audio signals, which are respectively a preset audio signal 1, a preset audio signal 2 and a preset audio signal 3, the pre-stored corresponding relationship between preset audio signals and corresponding IDs is as shown in Table 1 and the acquired audio signal related to the time information is a TV audio signal 1 is taken as an example.

TABLE 1

| preset audio signal | corresponding ID |
|---|---|
| preset audio signal1 | ID1 (Identity) |
| preset audio signal2 | ID2 |
| preset audio signal3 | ID3 |

If the preset audio signal 1 partially includes the TV audio signal 1 and the preset audio signal 2 and the preset audio signal 3 are irrelevant to the TV audio signal 1, it is determined that an ID corresponding to the TV audio signal 1 is an ID corresponding to the preset audio signal 1: ID1, and ID1 is used as an audio fingerprint corresponding to the TV audio signal 1.

If the preset audio signal 2 completely includes the TV audio signal 1 and the preset audio signal 1 and the preset audio signal 3 are irrelevant to the TV audio signal 1, it is determined that an ID corresponding to the TV audio signal 1 is an ID corresponding to the preset audio signal 2: ID2, and ID2 is used as an audio fingerprint corresponding to the TV audio signal 1.

If the preset audio signal 2 is completely included in the TV audio signal 1 and the preset audio signal 1 and the preset audio signal 3 are irrelevant to the TV audio signal 1, it is determined that an ID corresponding to the TV audio signal 1 is an ID corresponding to the preset audio signal 2: ID2, and ID2 is used as an audio fingerprint corresponding to the TV audio signal 1.

If the preset audio signal 2 partially includes the TV audio signal 1, the preset audio signal 2 partially includes the preset audio signal 3, and the preset audio signal 1 is irrelevant to the TV audio signal 1, it is determined that an ID corresponding to the TV audio signal 1 is an ID corresponding to the preset audio signal 2: ID2 and an ID corresponding to the preset audio signal 3: ID3, and ID2 and ID3 are used as an audio fingerprint corresponding to the TV audio signal 1.

Certainly, the number of the preset audio signals may also be another number, the name of the preset audio signals may also be another name, the pre-stored corresponding relationship between preset audio signals and corresponding IDs may also be another relationship, the relationship between the preset audio signal 1 and the TV audio signal 1, the relationship between the preset audio signal 2 and the TV audio signal 1 and the relationship between the preset audio signal 3 and the TV audio signal 1 may also be another relationship. This embodiment does not limit the specific number of the preset audio signals, the specific name of the preset audio signals, the specific pre-stored corresponding relationship between preset audio signals and corresponding IDs, the relationship between the preset audio signal 1 and the TV audio signal 1, the relationship between the preset audio signal 2 and the TV audio signal 1 and the specific relationship between the preset audio signal 3 and the TV audio signal 1.

In addition to the method for generating an audio fingerprint corresponding to the audio signal, the specific method for generating an audio fingerprint corresponding to the audio signal may also be: converting the audio signal to a symbol sequence composed of specific symbols, and using the symbol sequence as the audio fingerprint corresponding to the audio signal.

404: The terminal sends an interactive information acquisition request at least including the audio data and the time information.

This embodiment does not limit the specific method for sending an interactive information acquisition request at least including the audio data and the time information by the terminal. For example, if the terminal collects audio data once every first preset time period, the terminal sends an interactive information acquisition request at least including the collected audio data and the time information after collecting the audio data once every first preset time period.

By taking that the audio data is an audio signal in Example 1 of step 403 as an example, as the mobile phone A collects an audio signal 1 from 10:30:30 to 10:30:33, collects an audio signal 2 from 10:30:33 to 10:30:36, collects an audio signal 3 from 10:30:36 to 10:30:39, collects an audio signal 4 from 10:30:39 to 10:30:42 and collects an audio signal 5 from 10:30:42 to 10:30:45, the mobile phone A sends an interactive information acquisition request 11 at least including the audio signal 1 and 10:30:30, an interactive information acquisition request 12 at least including the audio signal 2 and 10:30:30, an interactive information acquisition request 13 at least including the audio signal 3 and 10:30:30, an interactive information acquisition request 14 at least including the audio signal 4 and 10:30:30 and an interactive information acquisition request 15 at least including the audio signal 5 and 10:30:30 in sequence every 3 s.

Certainly, the interactive information acquisition request may also be another name, and this embodiment does not limit the specific name of the interactive information acquisition request.

In addition, in order to reflect the time information of the audio data more accurately, optionally, the method for sending an interactive information acquisition request at least including the audio data and the time information by the terminal may also be: if the terminal collects audio data once every first preset time period, the terminal sends an interactive information acquisition request at least including the collected audio data, the time information and time information of collection of the audio data after collecting the audio data once every first preset time period.

Still by taking that the audio data is an audio signal in Example 1 of step 403 as an example, as the mobile phone A collects an audio signal 1 from 10:30:30 to 10:30:33, collects an audio signal 2 from 10:30:33 to 10:30:36, collects an audio signal 3 from 10:30:36 to 10:30:39, collects an audio signal 4 from 10:30:39 to 10:30:42 and collects an audio signal 5 from 10:30:42 to 10:30:45, time information of collection of the audio signal 1 is 10:30:30 to 10:30:33, time information of collection of the audio signal 2 is 10:30:33 to 10:30:36, time information of collection of the audio signal 3 is 10:30:36 to 10:30:39, time information of collection of the audio signal 4 is 10:30:39 to 10:30:42, and time information of collection of the audio signal 5 is 10:30:42 to 10:30:45. The mobile phone A sends an interactive information acquisition request 21 at least including the audio signal 1, 10:30:30 and 10:30:30 to 10:30:33, an interactive information acquisition request 22 at least including the audio signal 2, 10:30:30 and 10:30:33 to 10:30:36, an interactive information acquisition request 23 at least including the audio signal 3, 10:30:30 and 10:30:36 to 10:30:39, an interactive information acquisition request 24 at least including the audio signal 4, 10:30:30 and 10:30:39 to 10:30:42 and an interactive information acquisition request 25 at least including the audio signal 5, 10:30:30 and 10:30:42 to 10:30:45 in sequence every 3 s.

In addition to the method for sending an interactive information acquisition request at least including the audio data and the time information by the terminal, if the terminal only collects the audio data once, the method for sending an interactive information acquisition request at least including the audio data and the time information by the terminal may also be: sending, by the terminal, an interactive information acquisition request at least including the audio data and the time information only after collecting the audio data.

By taking that the audio data is an audio signal in Example 2 of step 403 as an example, as the mobile phone A collects an audio signal 6 from 10:30:30 to 10:30:33, the mobile phone A sends an interactive information acquisition request 6 at least including the audio signal 6 and 10:30:30.

In addition, for the situation where the terminal only collects the audio data once, in order to prevent sending failure caused by a network problem or other problems when an interactive information acquisition request at least including the audio data and the time information is sent in step 404, the method for sending an interactive information acquisition request at least including the audio data and the time information by the terminal may also be: sending, by the terminal, the same interactive information acquisition request every second preset time period, the interactive information acquisition request at least including the audio data and the time information.

Still by taking Example 2 in step 403 as an example, if the second preset time period is 3 s, as the mobile phone A collects an audio signal 6 from 10:30:30 to 10:30:33, an interactive information acquisition request 6 at least including the audio signal 6 and 10:30:30 is sent every 3 s.

Certainly, the second preset time period may also be another time length, and this embodiment does not limit the specific value of the second preset time period. The second preset time period may be the same as or different from the first preset time period in step 403, and this embodiment does not limit the relationship between the second preset time period and the first preset time period.

In addition, in order to provide different personalized services for different users, optionally, before the terminal sends an interactive information acquisition request at least including the audio data and the time information, user information may also be acquired. The specific method for sending an interactive information acquisition request at least including the audio data and the time information by the terminal may also be: sending an interactive information acquisition request at least including the audio data, the user information and the time information.

405: A server acquires the interactive information acquisition request.

The interactive information acquisition request at least includes the audio data and the time information.

The specific method for acquiring the interactive information acquisition request by a server changes with a change in the method for sending the interactive information acquisition request, and this embodiment does not limit the specific method for acquiring the interactive information acquisition request by a server, which includes, but is not limited to, if the method for sending the interactive information acquisition request is: sending, by the terminal, an interactive information acquisition request at least including the acquired audio data and the time information after collecting the audio data once every first preset time period, the method for acquiring the interactive information acquisition request by a server is: acquiring, by the server, the interactive information acquisition request every first preset time period, the interactive information acquisition request at least including the audio data and the time information.

If the method for sending the interactive information acquisition request is: sending, by the terminal, an interactive information acquisition request at least including the collected audio data, the time information and time information of collection of the audio data after collecting the audio data once every first preset time period, the method for acquiring the interactive information acquisition request by a server is: acquiring, by the server, the interactive information acquisition request every first preset time period, the interactive information acquisition request at least including the audio data, the time information and the time information of collection of the audio data.

If the method for sending the interactive information acquisition request is: sending, by the terminal, an interactive information acquisition request at least including the acquired audio data and the time information only after collecting the audio data once, the method for acquiring the interactive information acquisition request by a server is: acquiring, by the server, the interactive information acquisition request only once, the interactive information acquisition request at least including the audio data and the time information.

If the method for sending the interactive information acquisition request is: sending, by the terminal, the same interactive information acquisition request at least including the acquired audio data and the time information every second preset time period, and acquiring, by the server, the interactive information acquisition request every second preset time period, the interactive information acquisition request at least including the audio data and the time information.

406: The server acquires program information matching the audio data.

As the audio data is an audio signal or an audio fingerprint, if the audio data is an audio signal, the method for acquiring program information matching the audio data is: generating an audio fingerprint corresponding to the audio signal; sending the audio fingerprint to a signal providing device where program information such as audio fingerprints, program names and playback time information of respective programs is stored; and receiving program information matching the audio fingerprint. If the audio data is an audio fingerprint, the method for acquiring program information matching the audio data is: sending the audio fingerprint to a signal providing device where program information such as audio fingerprints, program names and playback time information of respective programs is stored; and receiving program information matching the audio fingerprint, wherein the program information at least includes an audio signal, name and playback time information of a program matching the audio fingerprint. This embodiment does not limit the specific method for acquiring program information matching the audio data.

By taking that the audio data acquired by the mobile phone A is an audio fingerprint and the audio fingerprint is ID1 as an example, a server A sends ID1 to a server B, and receives program information 1 matching ID1 returned by the server B: an audio signal of a TV program A played by a TV station A, the TV program A and 10:00:00 to 11:00:00.

Certainly, the name of the program information may be another name, the program information may be other content, and this embodiment does not limit the specific name of the program information and the specific content of the program information.

In addition, as the server may acquire a plurality of audio data in step 405, in step 406, whenever the server acquires the audio data, the server acquires program information matching the audio data.

By taking that the audio data acquired by the server A is an audio fingerprint as an example: after acquiring ID1, the server A acquires program information matching ID1. After acquiring ID2, the server A acquires program information matching ID2. After acquiring ID3, the server A acquires program information matching ID3. After acquiring ID4, the server A acquires program information matching ID4. After acquiring ID5, the server A acquires program information matching ID5.

407: The server acquires interactive information matching the program information and the time information, and sends the interactive information.

The content of the interactive information may include, but is not limited to, program public number attribute information/dialogue information, lottery draw/vote H5 interactive information, native payment information, native business details information, TV details information and the like, and this embodiment does not limit the specific content of the interactive information.

This embodiment does not limit the specific method for acquiring interactive information matching the program information and the time information by the server, which includes, but is not limited to: if the server pre-stores a corresponding relationship between program information, time information and interactive information, the server can, according to the pre-stored corresponding relationship between program information, time information and interactive information, acquire interactive information matching the program information and the time information.

By taking that the server A pre-stores a corresponding relationship between program information, time information and interactive information shown in Table 2, the program information is program information 1, and the time information is 10:30:30 as an example, the server A can acquire according to Table 2 that interactive information matching the program information 1 and 10:30:30 is interactive information 2 and interactive information 3.

TABLE 2

| program information | time information | interactive information |
|---|---|---|
| program information | 10:00:00 to | interactive information 1 |
| 1 | 10:30:00 | |
| program information | 10:30:00 to | interactive information 2 and |
| 1 | 11:00:00 | interactive information 3 |
| program information | 11:00:00 to | interactive information 4 |
| 2 | 12:00:00 | |

In addition, this embodiment does not limit the specific method for pre-storing a corresponding relationship between program information, time information and interactive information by the server. For example, the server pre-collects program information, and determines time information and interactive information corresponding to the program information; and the server stores a corresponding relationship between the program information, the time information and the interactive information according to the time information and the interactive information corresponding to the program information.

For example, the number of the program information pre-collected by the server A is two, which are respectively program information 1: an audio signal of a TV program A played by a TV station A, the TV program A and 10:00:00 to 11:00:00, and program information 2: an audio signal of a TV program B played by the TV station A, the TV program B and 12:00:00 to 12:00:00. The number of time information determined to correspond to the program information is two, which are respectively 10:00:00 to 10:30:00 and 10:30:00 to 11:00:00. Interactive information corresponding to the program information 1 and 10:00:00 to 10:30:00 is interactive information 1, and the number of interactive information corresponding to the program information 1 and 10:30:00 to 11:00:00 is two, which are respectively interactive information 2 and interactive information 3. The number of time information determined to correspond to the program information 2 is one, that is, 11:00:00 to 12:00:00. The number of interactive information corresponding to the program information 2 and 11:00:00 to 12:00:00 is one, that is, interactive information 4. The corresponding relationship between the program information, the time information and the interactive information stored by the server A according to the time information and the interactive information corresponding to the program information is as shown in Table 2.

Certainly, the number of the pre-collected program information may be another number, the number of the time information corresponding to the program information may be another number, the content of the time information corresponding to the program information may also be other content, the number of the interactive information corresponding to the program information and the time information may be another number, the name of the interactive information corresponding to the program information and the time information may be another name, the form of storing the corresponding relationship between the program information, the time information and the interactive information may be another form, and this embodiment does not limit the specific number of the pre-collected program information, the specific number of the time information corresponding to the program information, the specific content of the time information corresponding to the program information, the specific number of the interactive information corresponding to the program information and the time information, the specific name of the interactive information corresponding to the program information and the time information, and the specific form of storing the corresponding relationship between the program information, the time information and the interactive information.

It should be noted that, during execution of the method provided in this embodiment, the server does not need to pre-store the corresponding relationship between the program information, the time information and the interactive information each time, that is, the corresponding relationship between the program information, the time information and the interactive information is pre-stored only when the interactive information is acquired through the method provided in this embodiment for the first time. However, when the program information changes or the time information or the interactive information corresponding to the program information changes, that is, when it is necessary to update the stored corresponding relationship between the program information, the time information and the interactive information, the step of storing the corresponding relationship between the program information, the time information and the interactive information can be re-performed. Alternatively, the step of storing the corresponding relationship between the program information, the time information and the interactive information can be re-performed every third preset time period, so as to update the stored corresponding relationship between the program information, the time information and the interactive information. The third preset time period may be any time length, this embodiment does not limit the specific value of the third preset time period, and this embodiment does not limit the specific condition of triggering re-performing the step of storing the corresponding relationship between the program information, the time information and the interactive information.

In addition, if the acquired interactive information acquisition request further includes user information, the specific implementation method for acquiring interactive information matching the program information and the time information by the server may be: acquiring interactive information matching the program information, the user information and the time information.

This embodiment does not limit the specific method for acquiring interactive information matching the program information, the user information and the time information by the server, which includes, but is not limited to, if the server pre-stores a corresponding relationship between the program information, the user information, the time information and the interactive information, the server can acquire the interactive information matching the program information, the user information and the time information according to the pre-stored corresponding relationship between the program information, the user information, the time information and the interactive information.

By taking that the server A pre-stores a corresponding relationship between the program information, the user information, the time information and the interactive information shown in Table 3, the program information is program information 1, the time information is 10:30:30, and the user information is a user 1 as an example, the server A can acquire according to Table 3 that interactive information matching the program information 1, the user 1 and 10:30:30 is interactive information 2 and interactive information 3.

TABLE 3

| program | user | time | |
|---|---|---|---|
| information | information | information | interactive information |
| program | user 1 | 10:00:00 to | interactive information 1 |
| information 1 | | 10:30:00 | |
| program | user 1 | 10:30:00 to | interactive information 2 |
| information 1 | | 11:00:00 | and interactive information |
| | | | 3 |
| program | user 2 | 11:00:00 to | interactive information 4 |
| information2 | | 12:00:00 | |
| program | user 2 | 10:30:00 to | interactive information 4 |
| information2 | | 11:00:00 | |

In addition, this embodiment does not limit the specific method for pre-storing the corresponding relationship between the program information, the user information, the time information and the interactive information by the server. For example, the server pre-collects the program information, and determines the user information, the time information and the interactive information corresponding to the program information; and the server stores the corresponding relationship between the program information, the user information, the time information and the interactive information according to the user information, the time information and the interactive information corresponding to the program information.

For example, the number of the program information pre-collected by the server A is 2, which are respectively program information 1: an audio signal of a TV program A played by a TV station A, the TV program A and 10:00:00 to 11:00:00 and program information 2: an audio signal of a TV program B played by the TV station A, the TV program B and 11:00:00 to 12:00:00. It is determined that the number of user information corresponding to the program information 1 is one, that is, a user 1, the number of time information corresponding to the program information 1 is two, which are respectively 10:00:00 to 10:30:00 and 10:30:00 to 11:00:00. The interactive information corresponding to the program information 1 and 10:00:00 to 10:30:00 is interactive information 1, and the interactive information corresponding to the program information 1 and 10:30:00 to 11:00:00 is interactive information 2 and interactive information 3. It is determined that the number of user information corresponding to the program information 2 is one, that is, a user 1, and the number of time information corresponding to the program information 2 is one, that is, 11:00:00 to 12:00:00. The interactive information corresponding to the program information 2 and 11:00:00 to 12:00:00 is interactive information 4. The corresponding relationship between the program information, the time information and the interactive information stored by the server A according to the time information and the interactive information corresponding to the program information is as shown in Table 3.

Certainly, the number of the user information corresponding to the program information may be another number, the content of the user information corresponding to the program information may be other content, and this embodiment does not limit the specific number of the user information corresponding to the program information and the specific content of the user information corresponding to the program information.

It should be noted that, during execution of the method provided in this embodiment, the server does not need to pre-store the corresponding relationship between the program information, the user information, the time information and the interactive information each time, that is, the corresponding relationship between the program information, the user information, the time information and the interactive information is pre-stored only when the interactive information is acquired through the method provided in this embodiment for the first time. However, when the program information changes, or the user information corresponding to the program information changes, or the time information or the interactive information corresponding to the program information changes, that is, when it is necessary to update the stored corresponding relationship between the program information, the user information, the time information and the interactive information, the step of storing the corresponding relationship between the program information, the user information, the time information and the interactive information can be re-performed. Alternatively, the step of storing the corresponding relationship between the program information, the user information, the time information and the interactive information can be re-performed every fourth preset time period, so as to update the stored corresponding relationship between the program information, the user information, the time information and the interactive information. The fourth preset time period may be any time length, this embodiment does not limit the specific value of the fourth preset time period, and this embodiment does not limit the specific condition of triggering re-performing the step of storing the corresponding relationship between the program information, the user information, the time information and the interactive information. This embodiment does not limit whether the time length of the fourth preset time period is the same as that of the third preset time period either.

408: The terminal receives the interactive information.

If the interactive information sent in step 407 is interactive information matching the program information and the time information, the interactive information received in this step is interactive information matching the audio data and the time information in the interactive information acquisition request.

If the interactive information sent in step 407 is interactive information matching the program information, the user information and the time information, the interactive information received in this step is interactive information matching the audio data, the user information and the time information in the interactive information acquisition request.

In addition, after receiving the interactive information, the terminal may further display the received interactive information.

By taking that the interactive information received by the mobile phone A is vote interactive information as an example, the mobile phone A displays vote interactive information, as shown in FIG. 5(b).

In addition, the execution order of step 403 to step 408 only takes the order described in this embodiment as an example, during actual applications, the terminal, after performing step 403 to collect audio data once, may immediately perform step 404 to send an interactive information acquisition request at least including the audio data and the time information, the server, after performing step 405 to acquire the interactive information acquisition request and the time information, may perform step 406 and step 407 to match and send corresponding interactive information, and the terminal performs step 408 to receive the interactive information. If the terminal, when performing step 403, collects audio data in a manner of collecting the audio data once every first preset time period and after the terminal collects the audio data once, the total time of performing step 404 to step 408 is less than the first preset time period, that is, after collecting the audio data once, the terminal first receives the sent interactive information before the time of performing the step of collecting next audio data, and at this time, as the interactive information has been received, optionally, the step of collecting next audio data is no longer performed.

In addition, as the number of the interactive information acquired and sent by the server in step 407 may be multiple, the number of the interactive information received by the terminal in step 408 may also be multiple, and in order to reduce the number of the interactive information displayed, optionally, when receiving a plurality of interactive information, the terminal may first select one interactive information from the plurality of interactive information according to a preset selection strategy, and displays the selected interactive information.

In addition, after acquisition of the interactive information, if the interactive information further needs to perform subsequent information exchange between the terminal and the server to complete interactive content, at this time, the terminal may further continue to acquire information input or selected by a user according to the interactive information, sends the information to the server, and receives information returned by the server, so as to perform information exchange between the terminal and the server and complete subsequent steps of the interactive information.

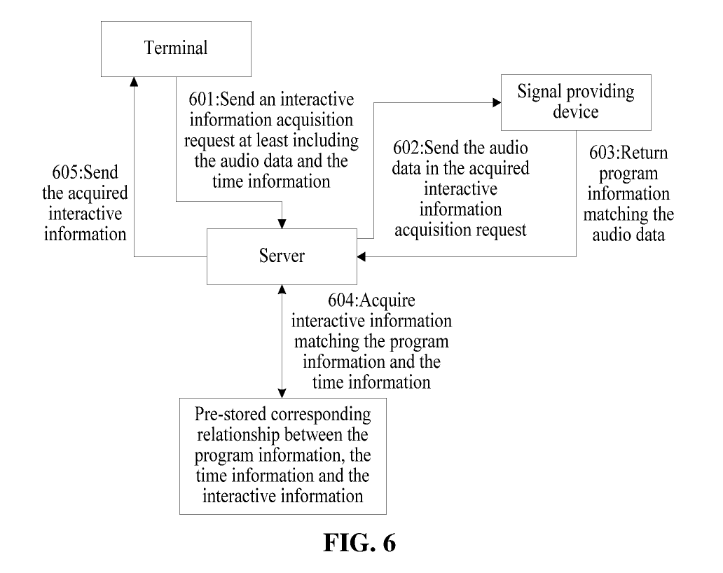

It should be noted that, during specific implementation of the method provided in this embodiment, it is feasible that, according to the implementation process shown in FIG. 6, the terminal determines time information of a shaking action after detecting the shaking action under the condition of opening an interactive function, acquires audio data related to the time information, and performs step 601 to send an interactive information acquisition request at least including the audio data and the time information. After acquiring the interactive information acquisition request, the server performs step 602 to send the audio data in the acquired interactive information acquisition request. A signal providing device performs step 603 to receive the audio data sent by the server and return program information matching the audio data. After acquiring the program information, the server performs step 604 to acquire interactive information matching the program information and the time information according to a pre-stored corresponding relationship between the program information, the time information and the interactive information, and performs step 605 to send the acquired interactive information.

In addition, at present, there are three methods for acquiring interactive information as follows:

The first method for acquiring interactive information: after a two-dimensional code for acquiring interactive information appears in a TV, scanning the two-dimensional code appearing in the TV through a mobile phone, and after the two-dimensional code is sent, receiving interactive information published by a public number corresponding to the two-dimensional code. At this time, a situation that low resolution of the TV causes failure of scanning of the two-dimensional code may occur, thereby causing a situation where acquisition of the interactive information fails.

The second method for acquiring interactive information: after acquisition description for acquiring interactive information appears in a TV, acquiring an interactive information acquisition instruction corresponding to the acquisition description input by a user through an input device, and after the interactive information acquisition instruction is sent, receiving interactive information matching the interactive information acquisition instruction. At this time, a situation where incorrect input of the interactive information acquisition instruction causes failure of acquisition of the interactive information may occur.

The third method for acquiring interactive information: after acquisition description for acquiring interactive information appears in a TV, acquiring an interactive information acquisition signal corresponding to the acquisition description sent by a user by operating a remote control, and after the interactive information acquisition signal is sent, receiving interactive information matching the interactive information acquisition signal. At this time, a situation where an incorrect operation on the remote control causes a wrong interactive information acquisition signal, thereby causing failure of acquisition of the interactive information may occur.

According to the method provided in this embodiment, after description for acquiring interactive information appears in a TV, the terminal acquires an interactive instruction and determines time information of the interactive instruction; acquires audio data related to the time information; sends an interactive information acquisition request at least including the audio data and the time information; and receives interactive information matching the audio data and the time information in the interactive information acquisition request, which avoids a situation where lower resolution of a device displaying the two-dimensional code causes failure of acquisition of the interactive information, and also avoids a situation where incorrect input of the interactive information acquisition instruction or an incorrect operation on the remote control causes failure of acquisition of the interactive information.

The method provided in this embodiment, by determining time information;
acquiring multimedia data related to the time information; sending an interactive information acquisition request at least including the multimedia data and the time information; and receiving interactive information matching the multimedia data and the time information in the interactive information acquisition request, avoids a situation where lower resolution of a device displaying the two-dimensional code causes failure of acquisition of the interactive information, and also avoids a situation where incorrect input of the interactive information acquisition instruction or an incorrect operation on the remote control causes failure of acquisition of the interactive information, thereby improving efficiency and accuracy of acquiring the interactive information.

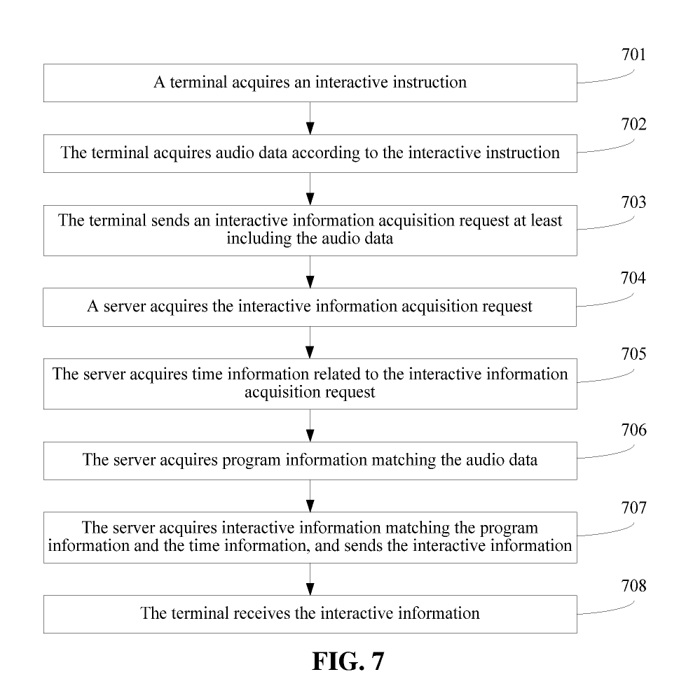

FIG. 7 is a flowchart of a method for acquiring interactive information illustrated according to one exemplary embodiment; for ease of description, this embodiment, by taking that the terminal is a mobile phone A, the server is a server A, the signal providing device is a server B, the multimedia data is audio data, and the server A acquires time information related to an interactive information acquisition request as an example, illustrates the method provided in this embodiment in details. Referring to FIG. 7, the flow of the method provided in this embodiment is specifically as follows:

701: A terminal acquires an interactive instruction.

Reference can be made to the description about step 401 in the embodiment shown in FIG. 4 for details of specific implementation of the step, which is not repeated herein.

702: The terminal acquires audio data according to the interactive instruction.

The audio data is an audio signal or an audio fingerprint. This embodiment does not limit the specific content representing the audio data.

For the situation where the audio data is an audio signal, during specific implementation of the step, it is feasible that the terminal collects an audio signal played by an audio playback device while the audio playback device plays audio, so as to achieve interaction through the audio signal played by the audio playback device. In addition, the audio signal may also be acquired according to the interactive instruction through another method, and this embodiment does not limit the specific method for acquiring audio data according to the interactive instruction.

This embodiment does not limit the specific method for collecting an audio signal by the terminal according to time information. For example, the terminal collects an audio signal once every first preset time period according to time information, until the total time length of collection of the audio signal reaches a preset length. Alternatively, the terminal collects an audio signal with a preset duration according to time information. In addition, this embodiment does not limit the audio playback device, which includes, but is not limited to, TV sets, radios and other audio playback devices.

### Example 1

by taking that the time information indicating that collection of the audio signal begins is 10:30:30 and the audio playback device is a TV set as an example, if the first preset time period is 3 s, the preset time length is 15 s, and the duration of every audio signal collection is 3 s, the mobile phone A, from 10:30:30 to 10:30:33, collects a TV audio signal 1 played from 10:30:30 to 10:30:33 by the TV set, and the TV audio signal 1 is used as an audio signal 1 collected for the first time; at this time, the total duration during which the audio signal is collected is 3 s.

From 10:30:33 to 10:30:36, a TV audio signal 2 played from 10:30:33 to 10:30:36 by the TV set is collected, the TV audio signal 2 is used as an audio signal 2 collected for the second time, and at this time, the total duration during which the audio signal is collected is 6 s.

From 10:30:36 to 10:30:39, a TV audio signal 3 played from 10:30:36 to 10:30:39 by the TV set is collected, the TV audio signal 3 is used as an audio signal 3 collected for the third time, and at this time, the total duration during which the audio signal is collected is 9 s.

From 10:30:39 to 10:30:42, a TV audio signal 4 played from 10:30:39 to 10:30:42 by the TV set is collected, the TV audio signal 4 is used as an audio signal 4 collected for the fourth time, and at this time, the total duration during which the audio signal is collected is 12 s.

From 10:30:42 to 10:30:45, a TV audio signal 5 played from 10:30:42 to 10:30:45 by the TV set is collected, the TV audio signal 5 is used as an audio signal 5 collected for the fifth time, at this time, the total duration during which the audio signal is collected is 15 s, which reaches the preset time length of 15 s, and audio signal collection is stopped.

In addition to the specific method for collecting an audio signal according to time information by the terminal, it may also be that the terminal only collects an audio signal once.

### Example 2

by taking that the time information indicating that collection of the audio signal begins is 10:30:30 and the audio playback device is a TV set as an example, if the duration of the audio signal collection is 3 s, the mobile phone A, from 10:30:30 to 10:30:33, collects a TV audio signal 6 played from 10:30:30 to 10:30:33 by the TV set, and the TV audio signal 6 is used as the acquired audio signal 6.

For the situation where the audio data is an audio fingerprint, during specific implementation of the step, it is feasible to first acquire an audio signal and then generate an audio fingerprint corresponding to the audio signal, so as to achieve interaction through the audio fingerprint corresponding to the audio signal.

703: The terminal sends an interactive information acquisition request at least including the audio data.

This embodiment does not limit the specific method for sending an interactive information acquisition request at least including the audio data by the terminal. For example, if the terminal collects audio data once every first preset time period, the terminal sends an interactive information acquisition request at least including the collected audio data after collecting the audio data once every first preset time period.

By taking that the audio data is an audio signal in Example 1 of step 702 as an example, as the mobile phone A collects an audio signal 1 from 10:30:30 to 10:30:33, collects an audio signal 2 from 10:30:33 to 10:30:36, collects an audio signal 3 from 10:30:36 to 10:30:39, collects an audio signal 4 from 10:30:39 to 10:30:42 and collects an audio signal 5 from 10:30:42 to 10:30:45, the mobile phone A sends an interactive information acquisition request 31 at least including the audio signal 1, an interactive information acquisition request 32 at least including the audio signal 2, an interactive information acquisition request 33 at least including the audio signal 3, an interactive information acquisition request 34 at least including the audio signal 4 and an interactive information acquisition request 35 at least including the audio signal 5 in sequence every 3 s.

Optionally, the method for sending an interactive information acquisition request at least including the audio data by the terminal may also be: if the terminal collects audio data once every first preset time period, the terminal sends an interactive information acquisition request at least including the collected audio data, the time information and time information of collection of the audio data after collecting the audio data once every first preset time period.

Still by taking that the audio data is an audio signal in Example 1 of step 702 as an example, as the mobile phone A collects an audio signal 1 from 10:30:30 to 10:30:33, collects an audio signal 2 from 10:30:33 to 10:30:36, collects an audio signal 3 from 10:30:36 to 10:30:39, collects an audio signal 4 from 10:30:39 to 10:30:42 and collects an audio signal 5 from 10:30:42 to 10:30:45, the mobile phone A sends an interactive information acquisition request 41 at least including the audio signal 1 and 10:30:30 to 10:30:33; an interactive information acquisition request 42 at least including the audio signal 2 and 10:30:33 to 10:30:36; an interactive information acquisition request 43 at least including the audio signal 3 and 10:30:36 to 10:30:39; an interactive information acquisition request 44 at least including the audio signal 4 and 10:30:39 to 10:30:42; and an interactive information acquisition request 45 at least including the audio signal 5 and 10:30:42 to 10:30:45 in sequence every 3 s.

In addition to the method for sending an interactive information acquisition request at least including the audio data and the time information by the terminal, if the terminal only collects the audio data once, the method for sending an interactive information acquisition request at least including the audio data by the terminal may also be: sending, by the terminal, the same interactive information acquisition request only after collecting the audio data, the interactive information acquisition request at least including the audio data.

By taking that the audio data is an audio signal in Example 2 of step 702 as an example, as the mobile phone A collects an audio signal 6 from 10:30:30 to 10:30:33, the mobile phone A sends an interactive information acquisition request 7 at least including the audio signal 6.

In addition, for the situation where the terminal only collects the audio data once, the method for sending an interactive information acquisition request at least including the audio data by the terminal may also be: sending, by the terminal, an interactive information acquisition request at least including the same audio data every second preset time period.

Still by taking Example 2 in step 702 as an example, if the second preset time period is 3 s, as the mobile phone A collects an audio signal 6 from 10:30:30 to 10:30:33, an interactive information acquisition request 7 at least including the audio signal 6 is sent every 3 s.

Optionally, before the terminal sends an interactive information acquisition request at least including the audio data, user information may also be acquired. The specific method for sending an interactive information acquisition request at least including the audio data by the terminal may also be: sending an interactive information acquisition request at least including the audio data and the user information.

704: A server acquires the interactive information acquisition request.

The interactive information acquisition request at least includes the audio data.

The specific method for acquiring the interactive information acquisition request by a server changes with a change in the method for sending the interactive information acquisition request, and this embodiment does not limit the specific method for acquiring the interactive information acquisition request by a server, which includes, but is not limited to, if the method for sending the interactive information acquisition request is: sending, by the terminal, an interactive information acquisition request at least including the acquired audio data after collecting the audio data once every first preset time period, the method for acquiring the interactive information acquisition request by a server is: acquiring, by the server, the interactive information acquisition request every first preset time period, the interactive information acquisition request at least including the audio data.

If the method for sending the interactive information acquisition request is: sending, by the terminal, an interactive information acquisition request at least including the acquired audio data and time information of collection of the audio data after collecting the audio data once every first preset time period, the method for acquiring the interactive information acquisition request by a server is: acquiring, by the server, the interactive information acquisition request every first preset time period, the interactive information acquisition request at least including the audio data and the time information of collection of the audio data.

If the method for sending the interactive information acquisition request is: sending, by the terminal, an interactive information acquisition request at least including the acquired audio data only after collecting the audio data once, the method for acquiring the interactive information acquisition request by a server is: acquiring, by the server, the interactive information acquisition request only once, the interactive information acquisition request at least including the audio data.

If the method for sending the interactive information acquisition request is: sending, by the terminal, the same interactive information acquisition request at least including the audio data every second preset time period, and acquiring, by the server, the interactive information acquisition request every second preset time period, the interactive information acquisition request at least including the audio data.

705: The server acquires time information related to the interactive information acquisition request.

This embodiment does not limit the specific method for acquiring time information related to the interactive information acquisition request by the server, which includes, but is not limited to, determining time information indicating that the interactive information acquisition request is acquired as time information related to the interactive information acquisition request. For example, if the time when the server acquires the interactive information acquisition request sent by the terminal is 10:30, the time information related to the interactive information acquisition request acquired by the server is also 10:30.

706: The server acquires program information matching the audio data.

Specific implementation of the step is identical with the principle of the description content of step 406 in the embodiment shown in FIG. 4, and the difference lies in that, the time information in step 406 is time information of the interactive instruction determined by the terminal, while the time information in the step is the time information related to acquisition of the interactive information acquisition request determined by the server, which is not repeated herein.

707: The server acquires interactive information matching the program information and the time information, and sends the interactive information.

Reference can be made to the description about step 407 in the embodiment shown in FIG. 4 for details of specific implementation of the step, and the difference lies in that, the time information in step 407 is time information of the interactive instruction determined by the terminal, while the time information in the step is the time information related to acquisition of the interactive information acquisition request determined by the server, which is not repeated herein.

708: The terminal receives the interactive information.

Reference can be made to the description about step 408 in the embodiment shown in FIG. 4 for details of specific implementation of the step, which is not repeated herein.

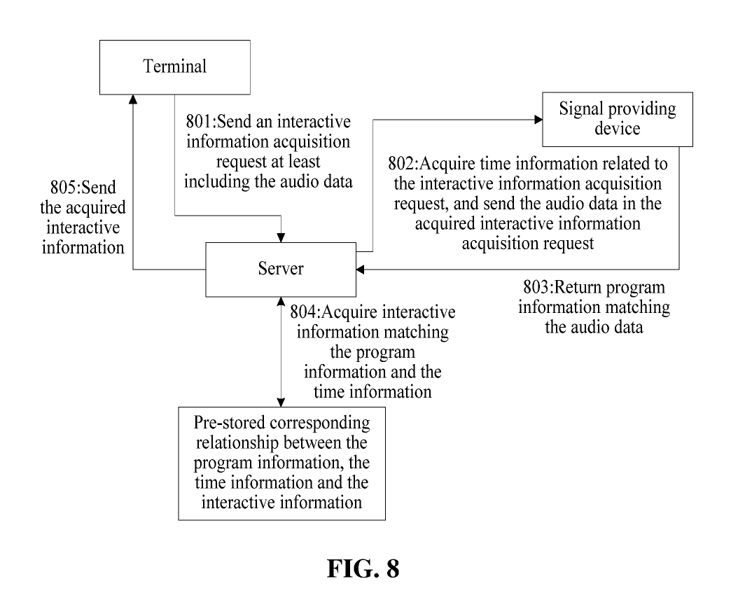

It should be noted that, during specific implementation of the method provided in this embodiment, it is feasible that, according to the implementation process shown in FIG. 8, the terminal acquires audio data of a shaking action after detecting the shaking action under the condition of opening an interactive function, and performs step 801 to send an interactive information acquisition request at least including the audio data. After acquiring the interactive information acquisition request, the server performs step 802 to acquire time information related to the interactive information acquisition request, and send the audio data in the acquired interactive information acquisition request. A signal providing device performs step 803 to receive the audio data sent by the server and return program information matching the audio data. After acquiring the program information, the server performs step 804 to acquire interactive information matching the program information and the time information according to a pre-stored corresponding relationship between the program information, the time information and the interactive information, and performs step 805 to send the acquired interactive information.

According to the method provided in this embodiment, a server receives an interactive information acquisition request at least including multimedia data sent by a terminal, acquires program information matching the multimedia data, acquires interactive information matching the multimedia data and the time information, and sends the interactive information to the terminal, which avoids a situation where lower resolution of a device displaying the two-dimensional code causes failure of acquisition of the interactive information, and also avoids a situation where incorrect input of the interactive information acquisition instruction or an incorrect operation on the remote control causes failure of acquisition of the interactive information, thereby improving efficiency and accuracy of acquiring the interactive information.

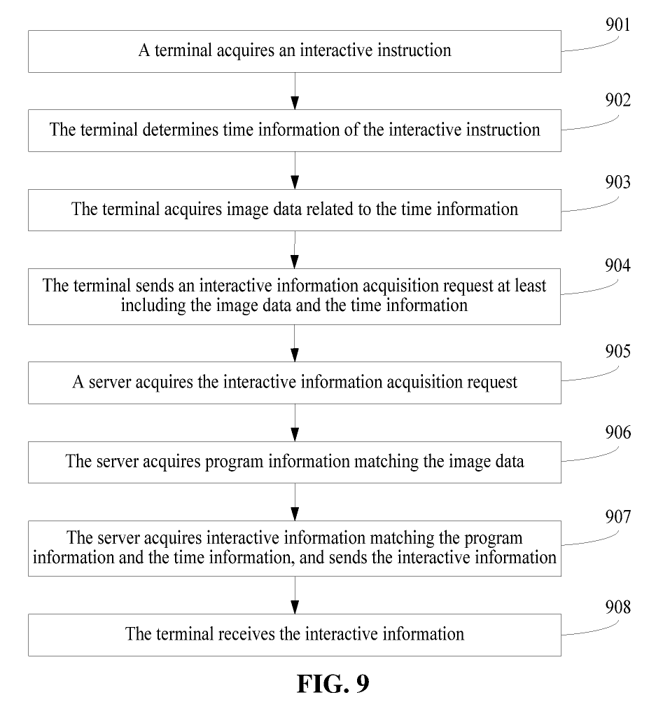

FIG. 9 is a flowchart of a method for acquiring interactive information illustrated according to one exemplary embodiment; for ease of description, this embodiment, by taking that the terminal is a mobile phone A, the server is a server A, the signal providing device is a server B, the multimedia data is image data, and the server A acquires time information of an interactive instruction as an example, illustrates the method provided in this embodiment in details. Referring to FIG. 9, the flow of the method provided in this embodiment is specifically as follows:

901: A terminal acquires an interactive instruction.

Reference can be made to the description about step 401 in the embodiment shown in FIG. 4 for details of specific implementation of the step, which is not repeated herein.

902: The terminal determines time information of the interactive instruction.

Reference can be made to the description about step 402 in the embodiment shown in FIG. 4 for details of specific implementation of the step, which is not repeated herein.

903: The terminal acquires image data related to the time information.

The image data may be picture data or video data, and this embodiment does not limit specific content representing the image data.

During specific implementation of the step, this embodiment does not limit the specific method for acquiring image data related to the time information, for example, while a video playback device plays back video, the terminal collects image data played by the video playback device according to the time information, so as to achieve interaction through the image data played by the video playback device.

This embodiment does not limit the specific method for collecting image data according to the time information by the terminal. For example, the terminal collects image data once every first preset time period, until the total time length of collection of the image data reaches a preset length. Alternatively, the terminal collects image data with a preset duration according to time information. In addition, this embodiment does not limit the video playback device, which includes, but is not limited to, TV sets, computers and other video playback devices.

### Example 1

by taking that the time information is 10:30:30 and the video playback device is a TV set as an example, if the first preset time period is 3 s, the preset time length is 15 s, and the duration of every video signal collection is 3 s, the mobile phone A, from 10:30:30 to 10:30:33, collects TV image data 1 played from 10:30:30 to 10:30:33 by the TV set, and the TV image data 1 is used as image data 1 collected for the first time; at this time, the total duration during which the image data is collected is 3 s.

From 10:30:33 to 10:30:36, TV image data 2 played from 10:30:33 to 10:30:36 by the TV set is collected, the TV image data 2 is used as image data 2 collected for the second time, and at this time, the total duration during which the image data is collected is 6 s.

From 10:30:36 to 10:30:39, TV image data 3 played from 10:30:36 to 10:30:39 by the TV set is collected, the TV image data 3 is used as image data 3 collected for the third time, and at this time, the total duration during which the image data is collected is 9 s.

From 10:30:39 to 10:30:42, TV image data 4 played from 10:30:39 to 10:30:42 by the TV set is collected, the TV image data 4 is used as image data 4 collected for the fourth time, and at this time, the total duration during which the image data is collected is 12 s.

From 10:30:42 to 10:30:45, a TV image data 5 played from 10:30:42 to 10:30:45 by the TV set is collected, the TV image data 5 is used as image data 5 collected for the fifth time, at this time, the total duration during which the image data is collected is 15 s, which reaches the preset time length of 15 s, and image data collection is stopped.

The TV image data may be pictures or video including TV programs, or pictures including station captions of TV stations of TV programs or the like.

Certainly, the video playback device may also be another device, the duration of every image data collection may also be another time length, the name of the collected image data may also be another name, and this embodiment does not limit the specific video playback device, the specific duration of every image data collection and the specific name of the collected image data.

In addition to the specific method for collecting image data according to the time information by the terminal, it may also be that the terminal collects image data only once according to the time information.

### Example 2

by taking that the time information is 10:30:30 and the video playback device is a TV set as an example, if the duration of the image data collection is 3 s, the mobile phone A, from 10:30:30 to 10:30:33, collects TV image data 6 played from 10:30:30 to 10:30:33 by the TV set, and the TV image data 6 is used as the collected image data 6.

904: The terminal sends an interactive information acquisition request at least including the image data and the time information.

The specific method for sending an interactive information acquisition request at least including the image data and the time information by the terminal may be: if the terminal collects image data once every first preset time period, sending, by the terminal, an interactive information acquisition request at least including the collected image data and the time information after collecting the image data once every first preset time period.

By taking Example 1 in step 903 as an example, as the mobile phone A collects the image data 1 from 10:30:30 to 10:30:33, collects the image data 2 from 10:30:33 to 10:30:36, collects the image data 3 from 10:30:36 to 10:30:39, collects the image data 4 from 10:30:39 to 10:30:42 and collects the image data 5 from 10:30:42 to 10:30:45, the mobile phone A sends an interactive information acquisition request 51 at least including the image data 1 and 10:30:30, an interactive information acquisition request 52 at least including the image data 2 and 10:30:30, an interactive information acquisition request 53 at least including the image data 3 and 10:30:30, an interactive information acquisition request 54 at least including the image data 4 and 10:30:30 and an interactive information acquisition request 55 at least including the image data 5 and 10:30:30 in sequence every 3 s.

In addition, in order to reflect the time information of the image data more accurately, optionally, the specific method for sending an interactive information acquisition request at least including the image data and the time information by the terminal may also be: if the terminal collects image data once every first preset time period, sending, by the terminal, an interactive information acquisition request at least including the collected image data, the time information and time information of collection of the image data after collecting the image data once every first preset time period.

Still by taking Example 1 in step 903 as an example, as the mobile phone A collects the image data 1 from 10:30:30 to 10:30:33, collects the image data 2 from 10:30:33 to 10:30:36, collects the image data 3 from 10:30:36 to 10:30:39, collects the image data 4 from 10:30:39 to 10:30:42 and collects the image data 5 from 10:30:42 to 10:30:45, time information of collection of the image data 1 is 10:30:30 to 10:30:33, time information of collection of the image data 2 is 10:30:33 to 10:30:36, time information of collection of the image data 3 is 10:30:36 to 10:30:39, time information of collection of the image data 4 is 10:30:39 to 10:30:42, and time information of collection of the image data 5 is 10:30:42 to 10:30:45. The mobile phone A sends an interactive information acquisition request 61 at least including the image data 1, 10:30:30 and 10:30:30 to 10:30:33; an interactive information acquisition request 62 at least including the image data 2, 10:30:30 and 10:30:33 to 10:30:36; an interactive information acquisition request 63 at least including the image data 3, 10:30:30 and 10:30:36 to 10:30:39; an interactive information acquisition request 64 at least including the image data 4, 10:30:30 and 10:30:39 to 10:30:42; and an interactive information acquisition request 65 at least including the image data 5, 10:30:30 and 10:30:42 to 10:30:45 in sequence every 3 s.

In addition to the method for sending an interactive information acquisition request at least including the image data and the time information by the terminal, if the terminal collects the image data only once, the method for sending an interactive information acquisition request at least including the image data and the time information by the terminal may also be: sending, by the terminal, the interactive information acquisition request at least including the image data and the time information only after collecting the image data.

By taking Example 2 in step 903 as an example, as the mobile phone A collects image data 6 from 10:30:30 to 10:30:33, the mobile phone A sends an interactive information acquisition request 8 at least including the image data 6 and 10:30:30.

In addition, for the situation where the terminal collects the image data only once, in order to prevent sending failure caused by a network problem or other problems when an interactive information acquisition request at least including the image data and the time information is sent in step 904, the method for sending an interactive information acquisition request at least including the image data and the time information by the terminal may also be: sending, by the terminal, the same interactive information acquisition request every second preset time period, the interactive information acquisition request at least including the image data and the time information.

Still by taking Example 2 in step 903 as an example, if the second preset time period is 3 s, as the mobile phone A collects image data 6 from 10:30:30 to 10:30:33, an interactive information acquisition request 8 at least including the image data 6 and 10:30:30 is sent every 3 s.

In addition, in order to provide different personalized services for different users, optionally, before the terminal sends an interactive information acquisition request at least including the image data and the time information, user information may also be acquired. The specific method for sending an interactive information acquisition request at least including the image data and the time information by the terminal may also be: sending an interactive information acquisition request at least including the image data, the user information and the time information.

905: A server acquires the interactive information acquisition request.

The interactive information acquisition request at least includes the image data and the time information.

The specific method for acquiring the interactive information acquisition request by a server changes with a change in the method for sending the interactive information acquisition request, and this embodiment does not limit the specific method for acquiring the interactive information acquisition request by a server, which includes, but is not limited to, if the method for sending the interactive information acquisition request is: sending, by the terminal, an interactive information acquisition request at least including the collected image data and the time information after collecting the image data once every first preset time period, the method for acquiring the interactive information acquisition request by a server is: acquiring, by the server, the interactive information acquisition request every first preset time period, the interactive information acquisition request at least including the image data and the time information.

If the method for sending the interactive information acquisition request is: sending, by the terminal, an interactive information acquisition request at least including the collected image data, the time information and time information of collection of the image data after collecting the image data once every first preset time period, the method for acquiring the interactive information acquisition request by a server is: acquiring, by the server, the interactive information acquisition request every first preset time period, the interactive information acquisition request at least including the image data, the time information and the time information of collection of the image data.

If the method for sending the interactive information acquisition request is: sending, by the terminal, an interactive information acquisition request at least including the image data and the time information only after collecting the image data once, the method for acquiring the interactive information acquisition request by a server is: acquiring, by the server, the interactive information acquisition request only once, the interactive information acquisition request at least including the image data and the time information.

If the method for sending the interactive information acquisition request is: sending, by the terminal, the same interactive information acquisition request at least including the image data and the time information every second preset time period, and acquiring, by the server, the interactive information acquisition request every second preset time period, the interactive information acquisition request at least including the image data and the time information.

906: The server acquires program information matching the image data.

This embodiment does not limit the specific method for acquiring program information matching the image data, for example, sending the image data to a signal providing device storing program information such as image data, program names and playback time information of various programs; and receiving program information matching the image data. The program information at least includes an audio signal, name and playback time information of a program matching the image data. As the image data is pictures or video of TV programs or station captions of TV stations of the TV programs, the program information matching the image data may be program information matching the pictures or video of TV programs or program information matching the station captions of TV stations of the TV programs.

By taking that the image data acquired by the server A is the image data 6 as an example, the server A sends the image data 6 to the server B, and receives program information 1 matching the image data 6 returned by the server B: an audio signal of a TV program A played by a TV station A, the TV program A and 10:00:00 to 11:00:00.

In addition, as the server may acquire a plurality of image data in step 905, in step 906, whenever the server acquires image data, the server acquires program information matching the image data.

By taking that the server A acquires image data as an example, after acquiring the image data 1, the server A acquires program information matching the image data 1. After acquiring the image data 2, the server A acquires program information matching the image data 2. After acquiring the image data 3, the server A acquires program information matching the image data 3. After acquiring the image data 4, the server A acquires program information matching the image data 4. After acquiring the image data 5, the server A acquires program information matching the image data 5.

907: The server acquires interactive information matching the program information and the time information, and sends the interactive information.

Reference can be made to the description about step 407 in the embodiment shown in FIG. 4 for details of specific implementation of the step, which is not repeated herein.

908: The terminal receives the interactive information.

Reference can be made to the description about step 408 in the embodiment shown in FIG. 4 for details of specific implementation of the step, which is not repeated herein.

The method provided in this embodiment, by determining time information of an interactive instruction; acquiring image data related to the time information; sending an interactive information acquisition request at least including the image data and the time information; and receiving interactive information matching the image data and the time information in the interactive information acquisition request, avoids the situation where lower resolution of a device displaying the two-dimensional code causes failure of acquisition of the interactive information and also avoids the situation where incorrect input of the interactive information acquisition instruction or an incorrect operation on the remote control causes failure of acquisition of the interactive information, thereby improving efficiency and accuracy of acquisition of the interactive information.

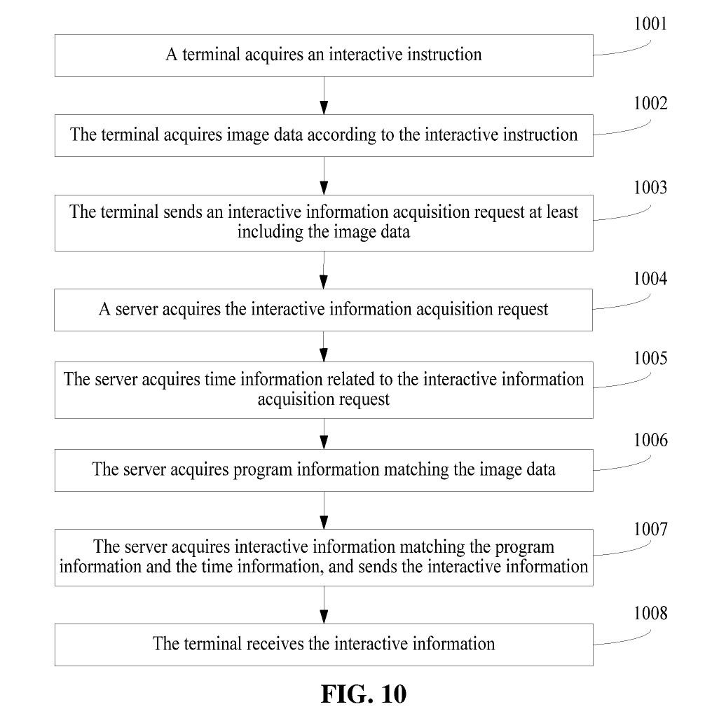

FIG. 10 is a flowchart of a method for acquiring interactive information illustrated according to one exemplary embodiment; for ease of description, in this embodiment, the method provided in this embodiment is illustrated in detail by taking that the terminal is a mobile phone A, the server is a server A, the signal providing device is a server B, the multimedia data is image data, and the mobile phone A acquires time information related to an interactive information acquisition request as an example. Referring to FIG. 10, the flow of the method provided in this embodiment is specifically as follows:

1001: A terminal acquires an interactive instruction.

Reference can be made to the description about step 401 in the embodiment shown in FIG. 4 for details of specific implementation of the step, which is not repeated herein.

1002: The terminal acquires image data according to the interactive instruction.

During specific implementation of the step, this embodiment does not limit the specific method for acquiring image data according to the interactive instruction, for example, after acquiring the interactive instruction, the terminal collects image data played by a video playback device while the video playback device plays back video, so as to achieve interaction through the image data played by the video playback device.

This embodiment does not limit the specific method for collecting image data by the terminal. For example, the terminal collects image data once every first preset time period, until the total time length of collection of the image data reaches a preset length. Alternatively, the terminal collects image data with a preset duration.

### Example 1

by taking that the time information indicating that image data collection begins is 10:30:30 and the video playback device is a TV set as an example, if the first preset time period is 3 s, the preset time length is 15 s, and the duration of every video signal collection is 3 s, the mobile phone A, from 10:30:30 to 10:30:33, collects TV image data 1 played from 10:30:30 to 10:30:33 by the TV set, and the TV image data 1 is used as image data 1 collected for the first time; at this time, the total duration during which the image data is collected is 3 s.

From 10:30:33 to 10:30:36, TV image data 2 played from 10:30:33 to 10:30:36 by the TV set is collected, the TV image data 2 is used as image data 2 collected for the second time, and at this time, the total duration during which the image data is collected is 6 s.

From 10:30:36 to 10:30:39, TV image data 3 played from 10:30:36 to 10:30:39 by the TV set is collected, the TV image data 3 is used as image data 3 collected for the third time, and at this time, the total duration during which the image data is collected is 9 s.

From 10:30:39 to 10:30:42, TV image data 4 played from 10:30:39 to 10:30:42 by the TV set is collected, the TV image data 4 is used as image data 4 collected for the fourth time, and at this time, the total duration during which the image data is collected is 12 s.

From 10:30:42 to 10:30:45, a TV image data 5 played from 10:30:42 to 10:30:45 by the TV set is collected, the TV image data 5 is used as image data 5 collected for the fifth time, at this time, the total duration during which the image data is collected is 15 s, which reaches the preset time length of 15 s, and image data collection is stopped.

In addition to the specific method for collecting image data according to the time information by the terminal, it may also be that the terminal collects image data only once according to the time information.

### Example 2

by taking that the time information indicating that image data collection begins is 10:30:30 and the video playback device is a TV set as an example, if the duration of the image data collection is 3 s, the mobile phone A, from 10:30:30 to 10:30:33, collects TV image data 6 played from 10:30:30 to 10:30:33 by the TV set, and the TV image data 6 is used as the collected image data 6.

1003: The terminal sends an interactive information acquisition request at least including the image data.

The specific method for sending an interactive information acquisition request at least including the image data by the terminal may be: if the terminal collects image data once every first preset time period, sending, by the terminal, an interactive information acquisition request at least including the collected image data after collecting the image data once every first preset time period.

By taking Example 1 in step 1002 as an example, as the mobile phone A collects the image data 1 from 10:30:30 to 10:30:33, collects the image data 2 from 10:30:33 to 10:30:36, collects the image data 3 from 10:30:36 to 10:30:39, collects the image data 4 from 10:30:39 to 10:30:42 and collects the image data 5 from 10:30:42 to 10:30:45, the mobile phone A sends an interactive information acquisition request 71 at least including the image data 1, an interactive information acquisition request 72 at least including the image data 2, an interactive information acquisition request 73 at least including the image data 3, an interactive information acquisition request 74 at least including the image data 4 and an interactive information acquisition request 75 at least including the image data 5 in sequence every 3 s.

Optionally, the specific method for sending an interactive information acquisition request at least including the image data by the terminal may also be: if the terminal collects image data once every first preset time period, sending, by the terminal, an interactive information acquisition request at least including the collected image data and time information of collection of the image data after collecting the image data once every first preset time period.

Still by taking Example 1 in step 1002 as an example, as the mobile phone A collects the image data 1 from 10:30:30 to 10:30:33, collects the image data 2 from 10:30:33 to 10:30:36, collects the image data 3 from 10:30:36 to 10:30:39, collects the image data 4 from 10:30:39 to 10:30:42 and collects the image data 5 from 10:30:42 to 10:30:45, the mobile phone A sends an interactive information acquisition request 81 at least including the image data 1 and 10:30:30 to 10:30:33; an interactive information acquisition request 82 at least including the image data 2 and 10:30:33 to 10:30:36; an interactive information acquisition request 83 at least including the image data 3 and 10:30:36 to 10:30:39; an interactive information acquisition request 84 at least including the image data 4 and 10:30:39 to 10:30:42; and an interactive information acquisition request 85 at least including the image data 5 and 10:30:42 to 10:30:45 in sequence every 3 s.

In addition to the method for sending an interactive information acquisition request at least including the image data by the terminal, if the terminal collects the image data only once, the method for sending an interactive information acquisition request at least including the image data by the terminal may also be: sending, by the terminal, the interactive information acquisition request at least including the image data only after collecting the image data.

By taking Example 2 in step 1002 as an example, as the mobile phone A collects image data 6 from 10:30:30 to 10:30:33, the mobile phone A sends an interactive information acquisition request 9 at least including the image data 6 and 10:30:30.

In addition, for the situation where the terminal collects the image data only once, the method for sending an interactive information acquisition request at least including the image data by the terminal may also be: sending, by the terminal, the same interactive information acquisition request every second preset time period, the interactive information acquisition request at least including the image data.

Still by taking Example 2 in step 1002 as an example, if the second preset time period is 3 s, as the mobile phone A collects image data 6 from 10:30:30 to 10:30:33, an interactive information acquisition request 9 at least including the image data 6 and 10:30:30 is sent every 3 s.

Optionally, before the terminal sends an interactive information acquisition request at least including the image data and the time information, user information may also be acquired. The specific method for sending an interactive information acquisition request at least including the image data by the terminal may also be: sending an interactive information acquisition request at least including the image data and the user information.

1004: A server acquires the interactive information acquisition request.

The interactive information acquisition request at least includes the image data.

The specific method for acquiring the interactive information acquisition request by a server changes with a change in the method for sending the interactive information acquisition request, and this embodiment does not limit the specific method for acquiring the interactive information acquisition request by a server, which includes, but is not limited to, if the method for sending the interactive information acquisition request is: sending, by the terminal, an interactive information acquisition request at least including the collected image data after collecting the image data once every first preset time period, the method for acquiring the interactive information acquisition request by a server is: acquiring, by the server, the interactive information acquisition request every first preset time period, the interactive information acquisition request at least including the image data.

If the method for sending the interactive information acquisition request is: sending, by the terminal, an interactive information acquisition request at least including the collected image data and time information of collection of the image data after collecting the image data once every first preset time period, the method for acquiring the interactive information acquisition request by a server is: acquiring, by the server, the interactive information acquisition request every first preset time period, the interactive information acquisition request at least including the image data and the time information of collection of the image data.

If the method for sending the interactive information acquisition request is: sending, by the terminal, an interactive information acquisition request at least including the image data only after collecting the image data once, the method for acquiring the interactive information acquisition request by a server is: acquiring, by the server, the interactive information acquisition request only once, the interactive information acquisition request at least including the image data.

If the method for sending the interactive information acquisition request is: sending, by the terminal, the same interactive information acquisition request at least including the image data every second preset time period, and acquiring, by the server, the interactive information acquisition request every second preset time period, the interactive information acquisition request at least including the image data.

1005: The server acquires time information related to the interactive information acquisition request.

Reference can be made to the description about step 705 in the embodiment shown in FIG. 7 for details of specific implementation of the step, which is not repeated herein.

1006: The server acquires program information matching the image data.

Reference can be made to the description about step 906 in the embodiment shown in FIG. 9 for details of specific implementation of the step, which is not repeated herein.

1007: The server acquires interactive information matching the program information and the time information, and sends the interactive information.

Reference can be made to the description about step 407 in the embodiment shown in FIG. 4 for details of specific implementation of the step, but the difference lies in that, the time information in step 407 is time information of the interactive instruction determined by the terminal, while the time information in the step is the time information related to acquisition of the interactive information acquisition request determined by the server, which is not repeated herein.

1008: The terminal receives the interactive information.

Reference can be made to the description about step 408 in the embodiment shown in FIG. 4 for details of specific implementation of the step, which is not repeated herein.

According to the method provided in this embodiment, a server receives an interactive information acquisition request at least including multimedia data sent by a terminal, acquires program information matching the multimedia data, acquires interactive information matching the program information and the time information, and sends the interactive information to the terminal, which avoids a situation where lower resolution of a device displaying the two-dimensional code causes failure of acquisition of the interactive information, and also avoids a situation where incorrect input of the interactive information acquisition instruction or an incorrect operation on the remote control causes failure of acquisition of the interactive information, thereby improving efficiency and accuracy of acquiring the interactive information.

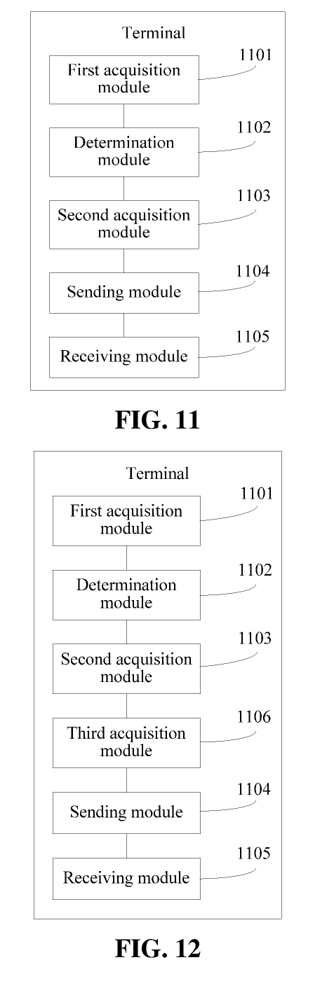

FIG. 11 is a terminal illustrated according to one exemplary embodiment; the terminal is configured to perform the functions performed by the terminal in the method for acquiring interactive information illustrated in any exemplary embodiment shown in FIG. 2, FIG. 4 to FIG. 6 and FIG. 9. Referring to FIG. 11, the terminal includes:
a first acquisition module 1101, configured to acquire an interactive instruction;
a determination module 1102, configured to determine time information of the interactive instruction acquired by the first acquisition module 1101;
a second acquisition module 1103, configured to acquire multimedia data related to the time information determined by the determination module 1102;
a sending module 1104, configured to send an interactive information acquisition request at least including the multimedia data acquired by the second acquisition module 1103 and the time information determined by the determination module 1102; and
a receiving module 1105, configured to receive interactive information matching the multimedia data and the time information in the interactive information acquisition request sent by the sending module 1104.

Optionally, the second acquisition module 1103 is configured to acquire an audio signal related to the time information, generate an audio fingerprint corresponding to the audio signal, and use the audio fingerprint as the acquired multimedia data.

Optionally, the second acquisition module 1103 is configured to acquire an audio signal related to the time information, and use the audio signal as the acquired multimedia data.

Optionally, the second acquisition module 1103 is configured to acquire image data related to the time information, and use the image data as the acquired multimedia data.

Referring to FIG. 12, the terminal further includes:
a third acquisition module 1106, configured to acquire user information;
wherein the sending module 1104 is configured to send an interactive information acquisition request at least including the multimedia data, the user information and the time information; and
the receiving module 1105 is configured to receive interactive information matching the multimedia data, the user information and the time information in the interactive information acquisition request.

The terminal provided in this embodiment, by determining time information of an interactive instruction; acquiring multimedia data related to the time information; sending an interactive information acquisition request at least including the multimedia data and the time information; and receiving interactive information matching the multimedia data and the time information in the interactive information acquisition request, avoids the situation where lower resolution of a device displaying the two-dimensional code causes failure of acquisition of the interactive information and also avoids the situation where incorrect input of the interactive information acquisition instruction or an incorrect operation on the remote control causes failure of acquisition of the interactive information, thereby improving efficiency and accuracy of acquisition of the interactive information.

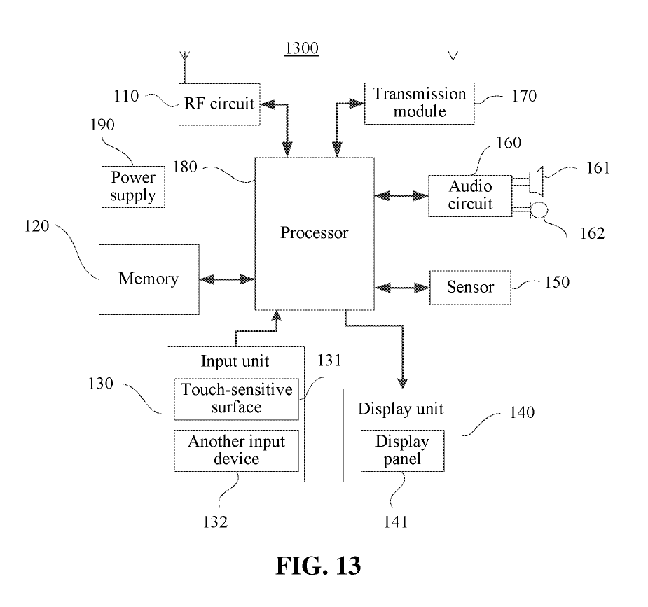

FIG. 13 is a terminal illustrated according to one exemplary embodiment; FIG. 13 illustrates a schematic structural diagram of a terminal having a touch-sensitive surface involved in the exemplary embodiment of the present invention, and the terminal can be configured to perform the functions performed by the terminal in the method for acquiring interactive information illustrated in any exemplary embodiment shown in FIG. 4 to FIG. 6 and FIG. 9. Specifically:

The terminal 1300 may include components such as a Radio Frequency (RF) circuit 110, a memory 120 including one or more computer readable storage mediums, an input unit 130, a display unit 140, a sensor 150, an audio circuit 160, a transmission module 170, a processor 180 including one or more processing cores, and a power supply 1100. A person skilled in the art may understand that the structure of the terminal shown in FIG. 13 does not constitute a limitation to the terminal, and the terminal may include more components or fewer components than those shown in the figure, or some components may be combined, or a different component deployment may be used.

The RF circuit 110 may be configured to receive and send signals during an information receiving and sending process or a call process. Particularly, the RF circuit 110 receives downlink information from a base station, then delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device by wireless communication. The wireless communication may use any communications standard or protocol, which includes, but is not limited to, Global System for Mobile communications (GSM), General Packet Radio Service (GPRS), Code Division Multiple Access (CDMA), Wideband Code Division Multiple Access (WCDMA), Long Term Evolution (LTE), e-mail, Short Messaging Service (SMS), and the like.

The memory 120 may be configured to store a software program and module, for example, the software program and module corresponding to the terminal illustrated in the exemplary embodiment shown in FIG. 11 or FIG. 12. The processor 180 runs the software program and module stored in the memory 120, to implement various functional applications and data processing, for example, achieve acquisition of interactive information and the like. The memory 120 may mainly include a program storage area and a data storage area. The program storage area may store an operating system, an application program required by at least one function (such as a sound playback function and an image playback function), and the like. The data storage area may store data (such as audio data and an address book) created according to use of the terminal 1300, and the like. In addition, the memory 120 may include a high speed random access memory, and may also include a non-volatile memory such as at least one magnetic disk storage device, a flash memory, or another volatile solid-state storage device. Correspondingly, the memory 120 may include a memory controller, to provide access of the processor 180 and the input unit 130 to the memory 120.

The input unit 130 may be configured to receive input digit or character information, and generate a keyboard, mouse, joystick, optical, or track ball signal input related to the user setting and function control. Specifically, the input unit 130 may include a touch-sensitive surface 131 and another input device 132. The touch-sensitive surface 131, which may also be referred to as a touch screen or a touch panel, may collect a touch operation of a user on or near the touch-sensitive surface (such as an operation of a user on or near the touch-sensitive surface 131 by using any suitable object or accessory, such as a finger or a stylus), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives touch information from the touch detection apparatus, converts the touch information into touch point coordinates, and sends the touch point coordinates to the processor 180. Moreover, the touch controller can receive and execute a command sent from the processor 180. In addition, the touch-sensitive surface 131 may be may be a resistive, capacitive, infrared, or surface sound wave type touch-sensitive surface. In addition to the touch-sensitive surface 131, the input unit 130 may further include the another input device 132. Specifically, the another input device 132 may include, but is not limited to, one or more of a physical keyboard, a functional key (such as a volume control key or a switch key), a track ball, a mouse, and a joystick.

The display unit 140 may be configured to display information input by the user or information provided for the user, and various graphical user interfaces of the terminal 1300. The graphical user interfaces may be formed by a graph, a text, an icon, a video, or any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine the type of the touch event. Then, the processor 180 provides a corresponding visual output on the display panel 141 according to the type of the touch event. Although, in FIG. 13, the touch-sensitive surface 131 and the display panel 141 are used as two separate parts to implement input and output functions, in some embodiments, the touch-sensitive surface 131 and the display panel 141 may be integrated to implement the input and output functions.

The terminal 1300 may further include at least one sensor 150, such as an optical sensor, a motion sensor, and other sensors. Specifically, the optical sensor may include an ambient light sensor and a proximity sensor. The ambient light sensor can adjust luminance of the display panel 141 according to brightness of the ambient light. The proximity sensor may switch off the display panel 141 and/or backlight when the terminal 1300 is moved to the ear. As one type of motion sensor, a gravity acceleration sensor can detect magnitude of accelerations in various directions (generally on three axes), may detect magnitude and a direction of the gravity when static, and may be applied to an application that recognizes the attitude of the mobile phone (for example, switching between landscape orientation and portrait orientation, a related game, and magnetometer attitude calibration), a function related to vibration recognition (such as a pedometer and a knock), and the like. Other sensors, such as a gyroscope, a barometer, a hygrometer, a thermometer, and an infrared sensor, which may be configured in the terminal 1300, are not further described herein.

The audio circuit 160, a loudspeaker 161, and a microphone 162 may provide audio interfaces between the user and the terminal 1300. The audio circuit 160 may convert received audio data into an electric signal and transmit the electric signal to the loudspeaker 161. The loudspeaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal device by using the RF circuit 110, or outputs the audio data to the memory 120 for further processing. The audio circuit 160 may further include an earplug jack, so as to provide communication between a peripheral earphone and the terminal 1300.

The terminal 1300 may help, by using the transmission module 170, the user to receive and send e-mails, browse a webpage, access streaming media, and so on, which provides wireless or wired broadband Internet access for the user. Although FIG. 13 shows the transmission module 170, it may be understood that the transmission module is not a necessary component of the terminal 1300, and when required, the transmission module may be omitted as long as the scope of the essence of the present disclosure is not changed.

The processor 180 is the control center of the terminal 1300, and is connected to various parts of the mobile phone by using various interfaces and lines. By running or executing the software program and/or module stored in the memory 120, and invoking data stored in the memory 120, the processor 180 performs various functions and data processing of the terminal 1300, thereby performing overall monitoring on the mobile phone. Optionally, the processor 180 may include one or more processing cores. Preferably, the processor 180 may integrate an application processor and a modem. The application processor mainly processes an operating system, a user interface, an application program, and the like. The modem mainly processes wireless communication. It may be understood that the foregoing modem may also not be integrated into the processor 180.

The terminal 1300 further includes the power supply 1100 (such as a battery) for supplying power to the components. Preferably, the power supply may be logically connected to the processor 180 by using a power management system, thereby implementing functions such as charging, discharging and power consumption management by using the power management system. The power supply 1100 may further include one or more of a direct current or alternating current power supply, a re-charging system, a power failure detection circuit, a power supply converter or inverter, a power supply state indicator, and any other components.

Although not shown in the figure, the terminal 1300 may further include a camera, a Bluetooth module, and the like, which are not further described herein. Specifically, in this embodiment, the display unit of the terminal is a touch screen monitor, and the terminal further includes a memory and one or more programs. The one or more programs are stored in the memory and configured to be executed by one or more processors. The one or more programs contain instructions for performing the following operations:
acquiring an interactive instruction;
determining time information of the interactive instruction;
acquiring multimedia data related to the time information;
sending an interactive information acquisition request at least including the multimedia data and the time information; and
receiving interactive information matching the multimedia data and the time information in the interactive information acquisition request.

On the assumption that the above is a first possible implementation, in a second possible implementation provided on the basis of the first possible implementation, the memory of the terminal further includes an instruction for performing the following operation:
acquiring an audio signal related to the time information, generating an audio fingerprint corresponding to the audio signal, and using the audio fingerprint as the acquired multimedia data.

In a third possible implementation provided on the basis of the first possible implementation, the memory of the terminal further includes an instruction for performing the following operation:
acquiring an audio signal related to the time information, and using the audio signal as the acquired multimedia data.

In a fourth possible implementation provided on the basis of the first possible implementation, the memory of the terminal further includes an instruction for performing the following operation:
acquiring image data related to the time information, and using the image data as the acquired multimedia data.

In a fifth possible implementation provided on the basis of the first, second, third or fourth possible implementation, the memory of the terminal further includes an instruction for performing the following operation:
acquiring user information;
sending an interactive information acquisition request at least including the multimedia data, the user information and the time information; and
receiving interactive information matching the multimedia data, the user information and the time information in the interactive information acquisition request.

To sum up, the terminal provided in this embodiment, by determining time information of an interactive instruction; acquiring multimedia data related to the time information; sending an interactive information acquisition request at least including the multimedia data and the time information; and receiving interactive information matching the multimedia data and the time information in the interactive information acquisition request, avoids the situation where lower resolution of a device displaying the two-dimensional code causes failure of acquisition of the interactive information and also avoids the situation where incorrect input of the interactive information acquisition instruction or an incorrect operation on the remote control causes failure of acquisition of the interactive information, thereby improving efficiency and accuracy of acquisition of the interactive information.

The exemplary embodiment illustrates a computer readable storage medium, and the computer readable storage medium may be the computer readable storage medium included in the memory illustrated in the exemplary embodiment shown in FIG. 13 or may be a computer readable storage medium existing separately and not assembled to the terminal. The computer readable storage medium stores one or more programs, and the one or more programs are used for performing acquisition of interactive information by one or more processors, the method including:
acquiring an interactive instruction;
determining time information of the interactive instruction;
acquiring multimedia data related to the time information;
sending an interactive information acquisition request at least including the multimedia data and the time information; and
receiving interactive information matching the multimedia data and the time information in the interactive information acquisition request.

On the assumption that the above is a first possible implementation, in a second possible implementation provided on the basis of the first possible implementation, the step of acquiring multimedia data related to the time information includes:
acquiring an audio signal related to the time information, generating an audio fingerprint corresponding to the audio signal, and using the audio fingerprint as the acquired multimedia data.

In a third possible implementation provided on the basis of the first possible implementation, the step of acquiring multimedia data related to the time information includes:
acquiring an audio signal related to the time information, and using the audio signal as the acquired multimedia data.

In a fourth possible implementation provided on the basis of the first possible implementation, the step of acquiring multimedia data related to the time information includes:
acquiring image data related to the time information, and using the image data as the acquired multimedia data.

In a fifth possible implementation provided on the basis of the first, second, third or fourth possible implementation, the method further includes:
acquiring user information;
the step of sending an interactive information acquisition request at least including the multimedia data and the time information including: sending an interactive information acquisition request at least including the multimedia data, the user information and the time information; and
the step of receiving interactive information matching the multimedia data and the time information in the interactive information acquisition request including: receiving interactive information matching the multimedia data, the user information and the time information in the interactive information acquisition request.

The computer readable storage medium provided in the embodiment of the present invention, by determining time information of an interactive instruction; acquiring multimedia data related to the time information; sending an interactive information acquisition request at least including the multimedia data and the time information; and receiving interactive information matching the multimedia data and the time information in the interactive information acquisition request, avoids the situation where lower resolution of a device displaying the two-dimensional code causes failure of acquisition of the interactive information and also avoids the situation where incorrect input of the interactive information acquisition instruction or an incorrect operation on the remote control causes failure of acquisition of the interactive information, thereby improving efficiency and accuracy of acquisition of the interactive information.

The exemplary embodiment illustrates a graphic user interface, the graphic user interface is used on the terminal illustrated in the exemplary embodiment shown in FIG. 11 or FIG. 12, and the terminal includes a touch screen monitor, a memory and a processor configured to perform one or more programs; the graphic user interface including:
acquiring an interactive instruction;
determining time information of the interactive instruction;
acquiring multimedia data related to the time information;
sending an interactive information acquisition request at least including the multimedia data and the time information; and
receiving interactive information matching the multimedia data and the time information in the interactive information acquisition request.

The graphic user interface provided in the embodiment of the present invention, by determining time information of an interactive instruction; acquiring multimedia data related to the time information; sending an interactive information acquisition request at least including the multimedia data and the time information; and receiving interactive information matching the multimedia data and the time information in the interactive information acquisition request, avoids the situation where lower resolution of a device displaying the two-dimensional code causes failure of acquisition of the interactive information and also avoids the situation where incorrect input of the interactive information acquisition instruction or an incorrect operation on the remote control causes failure of acquisition of the interactive information, thereby improving efficiency and accuracy of acquisition of the interactive information.

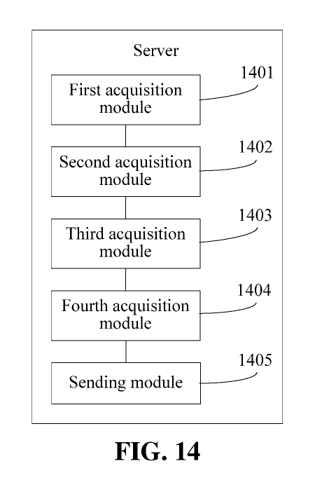

FIG. 14 is a server illustrated according to an exemplary embodiment; the server is configured to perform the functions performed by the server in the method for acquiring interactive information illustrated in any exemplary embodiment shown in FIG. 3, FIG. 7, FIG. 8 and FIG. 10. Referring to FIG. 14, the server includes:
a first acquisition module 1401, configured to acquire an interactive information acquisition request;
a second acquisition module 1402, configured to acquire time information related to the interactive information acquisition request acquired by the first acquisition module 1401, the interactive information acquisition request including multimedia data;
a third acquisition module 1403, configured to acquire program information matching the multimedia data;
a fourth acquisition module 1404, configured to acquire interactive information matching the program information acquired by the third acquisition module 1403 and the time information acquired by the second acquisition module 1402; and
a sending module 1405, configured to send the interactive information acquired by the fourth acquisition module 1404.

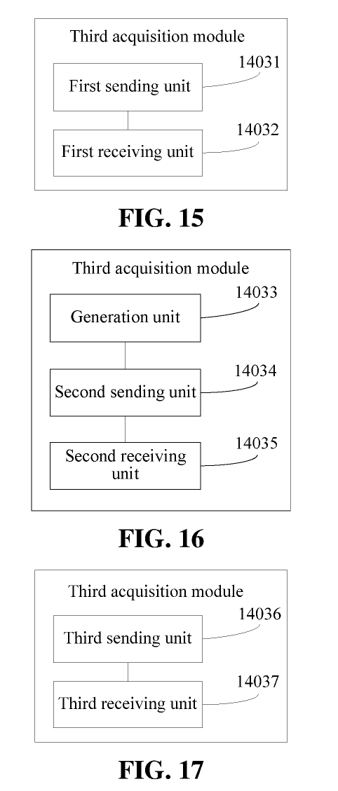

Referring to FIG. 15, the multimedia data is an audio fingerprint; and the third acquisition module 1403 includes:
a first sending unit 14031, configured to send the audio fingerprint; and
a first receiving unit 14032, configured to receive program information matching the audio fingerprint sent by the first sending unit 14031, the program information at least including an audio signal, name and playback time information of a program matching the audio fingerprint.

Referring to FIG. 16, the multimedia data is an audio signal; and the third acquisition module 1403 includes:
a generation unit 14033, configured to generate an audio fingerprint corresponding to the audio signal;
a second sending unit 14034, configured to send the audio fingerprint generated by the generation unit 14033; and
a second receiving unit 14035, configured to receive program information matching the audio fingerprint sent by the second sending unit 14034, the program information at least including an audio signal, name and playback time information of a program matching the audio fingerprint.

Referring to FIG. 17, the multimedia data is image data; and the third acquisition module 1403 includes:
a third sending unit 14036, configured to send the image data; and
a third receiving unit 14037, configured to receive program information matching the image data sent by the third sending unit 14036, the program information at least including an audio signal, name and playback time information of a program matching the image data.

Optionally, the interactive information acquisition request further includes user information; and
the fourth acquisition module 1404 is configured to acquire interactive information matching the program information, the user information and the time information.

The server provided in this embodiment, by receiving an interactive information acquisition request including multimedia data sent by a terminal, determining time information matching the interactive information acquisition request, and then returning interactive information matching the multimedia data and the time information to the terminal, avoids the situation where lower resolution of a device displaying the two-dimensional code causes failure of acquisition of the interactive information and also avoids the situation where incorrect input of the interactive information acquisition instruction or an incorrect operation on the remote control causes failure of acquisition of the interactive information, thereby improving efficiency and accuracy of acquisition of the interactive information.

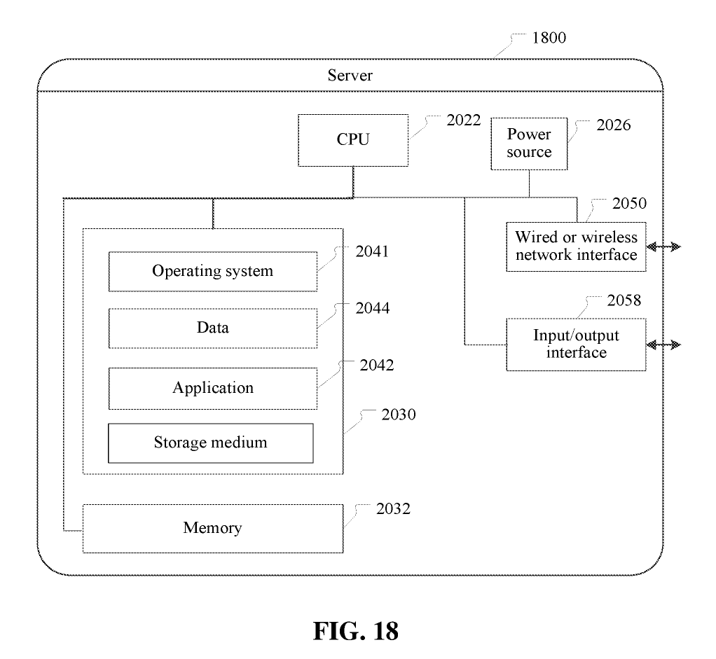

FIG. 18 is a server illustrated according to an exemplary embodiment, and the server can be configured to implement the functions performed by the server in the method for acquiring interactive information illustrated in any exemplary embodiment shown in FIG. 4, FIG. 8 and FIG. 10. Specifically, referring to FIG. 18, the server 1800 may vary significantly due to different configuration or performance, and may include one or more Central Processing Units (CPUs) 2022 (for example, one or more processors), a memory 2032, and one or more storage mediums 2030 (for example, one or more mass storage devices) storing applications 2042 or data 2044. The memory 2032 and the storage mediums 2030 may be temporary storage or persistent storage. The programs stored in the storage mediums 2030 may include one or more modules (not shown).

The server 1800 may further include one or more power sources 2026, one or more wired or wireless network interfaces 2050, one or more input/output interfaces 2058, and/or one or more operating systems 2041, for example, Windows Server™, Mac OS X™, Unix™, Linux™, FreeBSD™ and so on.

One or more programs are stored in the memory, and are configured to be executed by one or more processors, and the one or more programs include instructions configured to perform the following operations:
acquiring an interactive information acquisition request and time information related to the interactive information acquisition request, the interactive information acquisition request at least including multimedia data;
acquiring program information matching the multimedia data;
acquiring interactive information matching the program information and the time information; and
sending the interactive information.

On the assumption that the above is a first possible implementation, in a second possible implementation provided on the basis of the first possible implementation, instructions for performing the following operations are further included:
sending an audio fingerprint; and
receiving program information matching the audio fingerprint, the program information at least including an audio signal, name and playback time information of a program matching the audio fingerprint.

In a third possible implementation provided on the basis of the first possible implementation, instructions for performing the following operations are further included:
generating an audio fingerprint corresponding to the audio signal;
sending the audio fingerprint; and
receiving program information matching the audio fingerprint, the program information at least including an audio signal, name and playback time information of a program matching the audio fingerprint.

In a fourth possible implementation provided on the basis of the first possible implementation, instructions for performing the following operations are further included:
sending image data; and
receiving program information matching the image data, the program information at least including an audio signal, name and playback time information of a program matching the image data.

In a fifth possible implementation provided on the basis of the first, second, third or fourth possible implementation, an instruction for performing the following operation is further included:
acquiring interactive information matching the program information, the user information and the time information.

The server provided in this embodiment, by receiving an interactive information acquisition request including multimedia data sent by a terminal, determining time information matching the interactive information acquisition request, and then returning interactive information matching the multimedia data and the time information to the terminal, avoids the situation where lower resolution of a device displaying the two-dimensional code causes failure of acquisition of the interactive information and also avoids the situation where incorrect input of the interactive information acquisition instruction or an incorrect operation on the remote control causes failure of acquisition of the interactive information, thereby improving efficiency and accuracy of acquisition of the interactive information.

Another exemplary embodiment of the present invention provides a system for acquiring interactive information, the system being configured to perform the method for acquiring interactive information. The system includes: a terminal and a server.

The terminal is the terminal illustrated in the embodiment shown in FIG. 2, FIG. 11 to FIG. 13, and reference can be made to the exemplary embodiment for details, which is not repeated herein.

The server is the server illustrated in the embodiment shown in FIG. 3, FIG. 14 to FIG. 18, and reference can be made to the exemplary embodiment of the server for details, which is not repeated herein.

The system provided in this embodiment, by determining time information; acquiring multimedia data related to the time information; sending an interactive information acquisition request at least including the multimedia data and the time information; and receiving interactive information matching the multimedia data in the interactive information acquisition request and the time information related to the interactive information acquisition request, avoids the situation where lower resolution of a device displaying the two-dimensional code causes failure of acquisition of the interactive information and also avoids the situation where incorrect input of the interactive information acquisition instruction or an incorrect operation on the remote control causes failure of acquisition of the interactive information, thereby improving efficiency and accuracy of acquisition of the interactive information.

Another exemplary embodiment of the present invention provides a system for acquiring interactive information, the system being configured to perform the method for acquiring interactive information. The system includes: a terminal and a server.

The terminal is the terminal illustrated in any exemplary embodiment shown in FIG. 4, FIG. 6 and FIG. 9, and reference can be made to the exemplary embodiment for details, which is not repeated herein.

The server is the server illustrated in any exemplary embodiment shown in FIG. 4 to FIG. 6 and FIG. 9, and reference can be made to the exemplary embodiment of the server for details, which is not repeated herein.

The system provided in this embodiment, by determining time information; acquiring multimedia data related to the time information; sending an interactive information acquisition request at least including the multimedia data and the time information; and receiving interactive information matching the multimedia data and the time information in the interactive information acquisition request, avoids the situation where lower resolution of a device displaying the two-dimensional code causes failure of acquisition of the interactive information and also avoids the situation where incorrect input of the interactive information acquisition instruction or an incorrect operation on the remote control causes failure of acquisition of the interactive information, thereby improving efficiency and accuracy of acquisition of the interactive information.

Another exemplary embodiment of the present invention provides a system for acquiring interactive information, the system being configured to perform the method for acquiring interactive information. The system includes: a terminal and a server.

The terminal is the terminal illustrated in any exemplary embodiment shown in FIG. 7, FIG. 8 and FIG. 10, and reference can be made to the exemplary embodiment for details, which is not repeated herein.

The server is the server illustrated in any exemplary embodiment shown in FIG. 7, FIG. 8 and FIG. 10, and reference can be made to the exemplary embodiment of the server for details, which is not repeated herein.

The system provided in this embodiment, by sending an interactive information acquisition request at least including multimedia data; and receiving interactive information matching the multimedia data in the interactive information acquisition request and time information related to the interactive information acquisition request, avoids the situation where lower resolution of a device displaying the two-dimensional code causes failure of acquisition of the interactive information and also avoids the situation where incorrect input of the interactive information acquisition instruction or an incorrect operation on the remote control causes failure of acquisition of the interactive information, thereby improving efficiency and accuracy of acquisition of the interactive information.

It should be noted that the above functional modules are only described for exemplary purposes when the terminal and the server provided by the foregoing embodiments achieve acquisition of interactive information. In actual applications, the functions may be allocated to different functional modules according to specific needs, which means that the internal structures of the terminal and the server are divided to different functional modules to complete all or some of the above described functions. In addition, the terminal, the server and the system provided by the foregoing embodiments are based on the same concept as the method for acquiring interactive information in the foregoing embodiments. For the specific implementation process, refer to the method embodiments, and the details are not described herein again.

The sequence numbers of the foregoing embodiments of the present invention are merely for the convenience of description, and do not imply the preference among the embodiments.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

What is claimed is:

1. A method for acquiring interactive information, comprising:
acquiring an interactive instruction;
determining time information of the interactive instruction;
acquiring multimedia data related to the time information;
sending an interactive information acquisition request at least comprising the multimedia data and the time information; and
receiving interactive information matching the multimedia data and the time information in the interactive information acquisition request.

2. The method according to claim 1, wherein the acquiring multimedia data related to the time information comprises:
acquiring an audio signal related to the time information, generating an audio fingerprint corresponding to the audio signal, and using the audio fingerprint as the acquired multimedia data.

3. The method according to claim 1, wherein the acquiring multimedia data related to the time information comprises:
acquiring an audio signal related to the time information, and using the audio signal as the acquired multimedia data.

4. The method according to claim 1, wherein the acquiring multimedia data related to the time information comprises:
acquiring image data related to the time information, and using the image data as the acquired multimedia data.

5. The method according to claim 1, further comprising: acquiring user information;
the sending an interactive information acquisition request at least comprising the multimedia data and the time information comprising: sending an interactive information acquisition request at least comprising the multimedia data, the user information and the time information; and
the receiving interactive information matching the multimedia data and the time information in the interactive information acquisition request comprising: receiving interactive information matching the multimedia data, the user information and the time information in the interactive information acquisition request.

6. A terminal, comprising:
a processor and a plurality of instruction modules executed by the processor, the plurality of instruction modules comprising:
a first acquisition module, configured to acquire an interactive instruction;
a determination module, configured to determine time information of the interactive instruction acquired by the first acquisition module;
a second acquisition module, configured to acquire multimedia data related to the time information determined by the determination module;
a sending module, configured to send an interactive information acquisition request at least comprising the multimedia data acquired by the second acquisition module and the time information determined by the determination module; and
a receiving module, configured to receive interactive information matching the multimedia data and the time information in the interactive information acquisition request sent by the sending module.

7. The terminal according to claim 6, wherein the second acquisition module is configured to acquire an audio signal related to the time information, generate an audio fingerprint corresponding to the audio signal, and use the audio fingerprint as the acquired multimedia data.

8. The terminal according to claim 6, wherein the second acquisition module is configured to acquire an audio signal related to the time information, and use the audio signal as the acquired multimedia data.

9. The terminal according to claim 6, wherein the second acquisition module is configured to acquire image data related to the time information, and use the image data as the acquired multimedia data.

10. The terminal according to claim 6, wherein the terminal further comprises:
a third acquisition module, configured to acquire user information;
wherein the sending module is configured to send an interactive information acquisition request at least comprising the multimedia data, the user information and the time information; and
the receiving module is configured to receive interactive information matching the multimedia data, the user information and the time information in the interactive information acquisition request.

11. A server, comprising:
a processor and a plurality of instruction modules executed by the processor, the plurality of instruction modules comprising:
a first acquisition module, configured to acquire an interactive information acquisition request, the interactive information acquisition request at least comprising multimedia data;
a second acquisition module, configured to acquire time information related to the interactive information acquisition request acquired by the first acquisition module;
a third acquisition module, configured to acquire program information matching the multimedia data;
a fourth acquisition module, configured to acquire interactive information matching the program information acquired by the third acquisition module and the time information acquired by the second acquisition module; and
a sending module, configured to send the interactive information acquired by the fourth acquisition module.

12. The server according to claim 11, wherein the multimedia data is an audio fingerprint; and
the third acquisition module comprises:
a first sending unit, configured to send the audio fingerprint; and
a first receiving unit, configured to receive program information matching the audio fingerprint sent by the first sending unit, the program information at least comprising an audio signal, name and playback time information of a program matching the audio fingerprint.

13. The server according to claim 11, wherein the multimedia data is an audio signal; and
the third acquisition module comprises:
a generation unit, configured to generate an audio fingerprint corresponding to the audio signal;
a second sending unit, configured to send the audio fingerprint generated by the generation unit; and
a second receiving unit, configured to receive program information matching the audio fingerprint sent by the second sending unit, the program information at least comprising an audio signal, name and playback time information of a program matching the audio fingerprint.

14. The server according to claim 11, wherein the multimedia data is image data; and
the third acquisition module comprises:
a third sending unit, configured to send the image data; and
a third receiving unit, configured to receive program information matching the image data sent by the third sending unit, the program information at least comprising an audio signal, name and playback time information of a program matching the image data.

15. The server according to claim 11, wherein the interactive information acquisition request further comprises user information; and
the fourth acquisition module is configured to acquire interactive information matching the program information, the user information and the time information.
